(19) United States
(12) Patent Application Publication
(10) Pub. No.: US 2024/0038076 A1
(43) Pub. Date: Feb. 1, 2024

(54) ANTENNA EVALUATION TEST SYSTEM

(71) Applicant: Quadsta SPS, Odense N (DK)

(72) Inventors: Saki OMI, Greater Mnchester (GB); Joakim ESPELANDA, I, Otterup (GB)

(21) Appl. No.: 18/249,226

(22) PCT Filed: Oct. 15, 2021
(86) PCT No.: PCT/EP2021/078677

§ 371 Date: Apr. 14, 2023

(30) Foreign Application Priority Data
Oct. 16, 2020 (GB) 2016495.0
Aug. 6, 2021 (GB) 2111401.2

(51) Int. Cl. G08G 5/00; H04B 7/185; H04B 17/00

(52) U.S. Cl. CPC G08G 5/0039; H04B 7/18502; H04B 17/0085

(57) ABSTRACT

Methods, apparatus, and systems are provided for an antenna evaluation system including a control station and a plurality of unmanned aerial vehicles (UAVs) for evaluating the performance of an antenna under test (AUT). The UAVs including radio frequency (RF) sensor modules for receiving and/or transmitting RF signals from/to the AUT. The control station is configured to dynamically control the flight paths of each of the UAVs based on received RF measurements collected by the UAVs during antenna performance evaluation (APE) tests. The APE tests include performance evaluation tests including, without limitation, for example tracking performance, antenna pointing/de-pointing performance and/or any other APE in relation to the AUT. The AUT is a communication on the move (COTM) or satellite communication on the move (SOTM) antenna. For antennas used in satellite communications, the control station may configure the UAVs to mimic a satellite and/or track AUT's beam center when installed on a moving vehicle such as, without limitation, for example a land based vehicle, maritime vehicle, ship, aircraft and any other vehicle onto which the antenna is mounted.

The present application relates to a system, apparatus and method of an antenna evaluation system using multiple aircraft or unmanned aerial vehicle(s) (UAV(s)) for testing an antenna under test (AUT) and applications thereto.

### BACKGROUND

Typically evaluation of the satellite antenna performance for Satellite communications On-The-Move (SOTM/COTM) applications that may be used on various vehicles such as, for example, ships, airplanes, and/or land vehicles is expensive and difficult. Specifically, for example, tracking performance or pointing accuracy of the ground antenna on a vehicle to the satellite has to be accurate during normal operations of the vehicle in order to guarantee high throughput performance without interfering with other communications.

Conventionally, SOTM antenna evaluation is performed by sending the antenna to a test measurement facility specific to the antenna's size, model and functionality or having the land vehicle, ship or airplane drive, sail or fly around while the antenna tracking/pointing is calibrated. This is an expensive and laborious process, and it would be advantageous to have a more cost-effective and efficient system for realistically evaluating satellite antenna performance either at a test facility prior to installation of an antenna on a vehicle and/or in situ after installation of an antenna with the vehicle stationary.

Along with the satellite industry growth, the need to evaluate the satellite antenna and its system has become eminent. It is required to verify that the satellite communication system on the ground does not hinder the other communications by emitting some unintended signal which is regarded as “interference”. Also, it is necessary to guarantee secured and solid networks between satellites and the terrestrial terminal. Satellite Communication On-The-Move (SOTM) or Communication On-The-Move (COTM) are types of systems whose terminal antennas are mounted on the moving vehicle and establish a satellite communication and/or telecoms communication. The key requirement for COTM/SOTM application is to keep tracking the intended satellite or telecommunications terminals/base stations without interfering with other communications in addition to keep its radiation pattern (antenna pattern) within the acceptable shape. COTM and SOTM may be used interchangeably in this disclosure.

In order to numerically evaluate the COTM tracking accuracy, Fraunhofer IIS, in collaboration with the Teschniche Univeraitat in Ilmenau, has established a Facility for Over-the-air Research and Testing (FORTE), which has been authorized by a test entity of Global VSAT Forum (GVF). FORTE can emulate the complete COTM reality on the Earth without involving satellites and vehicles by controlling a motion emulator and 5 sensors on the crossed lines to measure the received signal. However, because of the steep increase in demand, building more of these types of facilities to provide the same service would be expensive and infeasible to evaluate all newly developed COTM antennas under SOMAP criteria. Also, it is not easy to adjust the configuration of the system depending on the test antenna characteristics and scenarios. For example, due to the static sensors, it does not provide an accurate tracking evaluation for the types of antennas which varies their radiation pattern depending on the steering angles. In addition, the target satellite is limited to the ones on geostationary orbit; the demand for low earth orbit satellite communications is however increasing, which means systems such as FORTE are becoming obsolete or require expensive upgrading to provide such testing facilities.

There is a desire for a more improved antenna test system or methodology that is capable of performing cost-effective real-time Radio Frequency (RF) measurements and efficient processing of the RF radiation data when evaluating the performance of an antenna under test (AUT), and that overcomes at least one or more of the above disadvantages.

The embodiments described below are not limited to implementations, which solve any, or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

The present disclosure provides a method(s), apparatus and system(s) for evaluating an antenna under test (AUT) using a control station and a plurality of unmanned aerial vehicles (UAVs), the UAVs including radio frequency (RF) sensor modules for receiving and/or transmitting RF signals from/to the AUT, and the control station is being configured to dynamically control the flight paths of each of the UAVs based on received RF measurements collected by the UAVs during antenna performance evaluation (APE) tests. Alternatively, the APE tests, more specifically tracking accuracy test and/or pointing accuracy test, may be performed without dynamically controlling the flight paths. That is, the APE tests include performance evaluation tests including, without limitation, for example tracking performance, antenna pointing/de-pointing performance and/or any other APE in relation to the AUT.

As an option, a machine learning model configured for estimating pointing, de-pointing, tracking of an AUT and for generating UAV trajectories for adjusting the flight paths of the UAVs during an APE test may be trained based on a ML technique using previously collected RF measurements by the UAVs in relation to the AUT. The ML technique may be based on, without limitation, for example reinforcement learning and/or any other suitable ML technique. As an example, a multi-agent reinforcement learning system may be trained for use in evaluating the tracking accuracy performance of the AUT and assisting a control station in remotely and/or dynamically controlling the plurality of UAVs during the APE tests and the like.

As another option, the AUT is a communication on the move (COTM) or satellite communication on the move (SOTM) antenna. For antennas used in satellite and/or long range communications, the control station may configure the UAVs to mimic trajectory of a satellite in LEO/MEO and/or motion of the vehicle where AUT is mounted by remotely controlling the flight path of the UAVs. The AUT may be designed to be installed on a moving vehicle such as, without limitation, for example a land based vehicle, maritime vehicle, ship, aircraft and any other vehicle onto which the antenna is mounted.

In a first aspect, the present disclosure provides a computer-implemented method of testing an antenna under test (AUT) in an antenna evaluation system comprising a control unit/station and a plurality of aircraft in communication with the control unit, each aircraft including a radio frequency (RF) sensor module for use in measuring RF radiation and/or testing the AUT, the method, performed by the control station/unit, comprising: controlling the flight paths of each of the aircraft around the AUT for collecting RF radiation measurements in relation to one or more antenna performance tests; and evaluating the antenna performance of the AUT based on the collected RF radiation measurements of the AUT in relation to the one or more antenna performance tests.

As an option, the computer-implemented method of the first aspect further comprising: receiving in-flight positions of each of the aircraft during testing of the AUT; receiving RF radiation associated with the AUT measured by each of the aircraft along each flight path taken by said aircraft; dynamically controlling the flight paths of each of the aircraft around the AUT for one or more antenna performance tests based on the real-time in-flight position of the aircraft and the received RF radiation of the AUT from each of the aircraft; and evaluating the antenna performance of the AUT based on the received RF radiation from the AUT in relation to the one or more antenna performance tests.

As an option, the computer-implemented method of the first aspect, wherein each of the plurality of aircraft is configured to: receive dynamic flight path information from the control unit; measure RF radiation associated with the AUT along the received dynamic flight path taken by said each aircraft; and transmit the RF radiation measurements to the control unit.

As an option, the computer-implemented method of the first aspect, wherein the one or more antenna performance tests include one or more from the group of: antenna tracking performance test; antenna pointing performance test; antenna de-pointing performance test; SOTM antenna performance tests; COTM antenna performance tests; GVF-105 antenna performance tests; any other suitable antenna performance evaluation test in relation to the AUT.

As an option, the computer-implemented method of the first aspect, wherein prior to dynamically controlling the flight paths, or in the absence of being dynamically controlled thereof, and evaluating the antenna performance of the AUT the method further comprising performing: a Site Survey and System Calibration phase for surveying the test site of the AUT and calibration of the RF sensor modules of the aircraft; an Antenna radiation pattern measurement phase for measuring RF radiation pattern of the AUT including main beam localization; and a data processing and analysis phase for performing an AUT tracking accuracy testing phase; and the AUT tracking accuracy testing phase for estimating the antenna performance of the AUT based on one or more antenna performance tests.

As an option, the computer-implemented method of the first aspect, wherein the AUT test phase is an AUT pointing test phase when the antenna performance test is a pointing accuracy test.

As an option, the computer-implemented method of the first aspect, wherein prior to dynamically controlling the flight paths, or in the absence of being dynamically controlled thereof, and evaluating the antenna performance of the AUT the method further comprising: in the Survey and System Calibration phase: performing a site survey of the test area around the AUT and calibration of the RF sensors of the aircraft based on controlling the flight paths of the plurality of aircraft planned on-line and/or off-line and measuring RF radiation and/or objects observed by the aircraft for determining obstacles to avoid during the antenna performance tests and RF interference for calibrating the RF sensors of the aircraft; in the Antenna radiation pattern measurement phase: performing antenna radiation pattern measurements by controlling the flight paths planned on-line and/or off-line of each of the aircraft to fly around the area of the AUT for receiving the RF measurements and corresponding in-flight positions for determining the radiation pattern of the AUT; in the data processing and analysis phase: analysing the RF measurements and positional information for determining characteristics of the AUT for use in an antenna performance test; in the AUT tracking accuracy test phase: performing an antenna performance test based on the steps of: dynamically controlling each of the aircraft for performing one or more antenna performance tests, or in the absence of a dynamic control system configured for the antenna performance test, and collecting RF measurements and corresponding positional information associated with the AUT; analysing the collected RF measurements and corresponding positional information for updating the trajectories/flight paths of the aircraft for collecting further RF measurements and corresponding positional information; and evaluating the collected RF measurements and corresponding positional information for determining the antenna performance based on the one or more antenna performance tests.

In the above option, and associated with other aspects of the invention, the data processing and analysis phase may incorporate other processes depending on the method chosen in the tracking accuracy test. These processes are further described herein as alternative options or aspects and as part of the description.

As an option, the computer-implemented method of the first aspect, wherein the antenna performance is output for use in maintaining, overhauling, re-calibrating, re-designing, adjusting the antenna and/or configuration of the antenna and the like.

As an option, the computer-implemented method of the first aspect, wherein in the data processing and analysis phase, performing one or more of: analysing the RF measurements and positional information for assisting in antenna performance tests including the antenna tracking and/or pointing tests; performing a tracking/pointing analysis in preparation for one or more of the antenna performance tests associated with tracking/pointing/de-pointing; performing an analysis of the RF measurements and corresponding positional information for determining aircraft positioning in relation to the antenna of the AUT in preparation for one or more of the antenna performance tests; and building a machine learning, ML, model/system based on inputting a training data set to a machine learning algorithm or technique, the training data set comprising data representative of RF measurement data and corresponding positional information associated with the AUT collected during the antenna radiation pattern measurement phase, wherein the ML model/system is configured to output an estimate of antenna performance of the AUT associated with an antenna performance test and/or output in-flight trajectory updates for dynamically controlling the aircraft for receiving further RF measurements and corresponding positional information based on previously received RF measurements and corresponding positional information from said aircraft during the antenna performance test;

As an option, the computer-implemented method of the first aspect, wherein in the AUT test phase: simulating motion of the AUT during one or more antenna performance tests based on one or more of: dynamically controlling the flight paths of the plurality of aircraft UAVs to simulate motion of the vehicle where AUT is installed; mounting the AUT on a motion emulator for simulating motion of the AUT;

As an option, the computer-implemented method of the first aspect, wherein the simulated motion is based on simulating motion of one or more vehicle types from the group of: land-based vehicles; maritime vehicles or ships; aircraft; high-speed trains; and any other platform onto which the AUT may be mounted that experiences motion during operation of the AUT.

As an option, the computer-implemented method of the first aspect, wherein in the AUT test phase, when an ML model/system is associated with an antenna performance test, the ML model/system receives as input data representative of real-time RF measurements and corresponding positional information from said aircraft and outputs an estimate of the antenna performance associated with the antenna performance test and/or updates or adjustments for dynamically controlling the flight paths of one of more of the aircraft for directing said aircraft to measure further RF measurements and corresponding positional information for estimating the antenna performance.

As an option, the computer-implemented method of the first aspect, wherein the trained ML model/system is configured to provide control/navigation values for aircraft in real-time/on-line immediately during the AUT test phase and/or provide waypoints for aircraft to move to for maintaining accuracy should the AUT main beam direction be mismatched from an initial state during the RF measurement in the AUT test phase.

As an option, the computer-implemented method of the first aspect, wherein in the AUT test phase when the test is a pointing accuracy test, the RF measurements are RF de-pointing measurements. As an option, the computer-implemented method of the first aspect, wherein the ML model/system is a reinforcement learning, RL, system derived from an associated RL technique. As an option, the computer-implemented method of the first aspect, wherein the RL system is configured based on a centralised critic and centralised actor/agent.

As an option, the computer-implemented method of the first aspect, wherein the RL system is configured based on a centralised critic and a plurality of decentralised actors/agents. As an option, the computer-implemented method of the first aspect, wherein the RL system is configured based on a decentralised critic and a plurality of decentralised actors/agents. As an option, the computer-implemented method of the first aspect, wherein the RL system is based on multi-agent reinforcement learning algorithm(s).

As an option, the computer-implemented method of the first aspect, wherein in the Antenna radiation pattern measurement phase: performing antenna radiation pattern measurements further comprising controlling the flight paths of each of the aircraft to find at least the main beam lobe and/or side lobe of the AUT; and collecting RF measurements and corresponding positional information from each of the aircraft.

In the above option, when performing the antenna radiation pattern measurements, the method accommodates for a single beam localization for a fixed pattern AUT and multi-beam localization for a varying pattern AUT. Single and multiple beam localizations are further described herein as alternative options or aspects and as part of the description.

As an option, the computer-implemented method of the first aspect, wherein in the Antenna radiation pattern measurement phase: estimating the centre of the main beam lobe of the AUT based on an iterative feedback algorithm/system using Bayesian estimation techniques and/or ML techniques and the RF radiation measurements and positional information; autonomously and dynamically adjusting the position and orientation of a circle or spiral defining each of the aircraft's flight paths based on the estimated beam centre, wherein flight path adjustments are dynamically generated by the control unit and sent to the each of the corresponding aircraft in each iteration of the iterative feedback algorithm/system.

As an option, the computer-implemented method of the first aspect, wherein in the Antenna radiation pattern measurement phase: estimating the centre of the main beam lobe of the AUT based on an iterative gradient ascent algorithm using the RF radiation measurements and positional information; autonomously and dynamically adjusting the position and orientation of each of the aircraft's flight paths based on the estimated beam centre, wherein flight path adjustments are dynamically generated by the control unit and sent to the each of the corresponding aircraft in each iteration of the gradient ascent algorithm or raster scan approach or cross-section approach.

As an option, the computer-implemented method of the first aspect, wherein in the AUT test phase, the method further comprising: designating at least one aircraft to be a pseudo satellite and a plurality of other aircraft to form a flight formation around the pseudo satellite aircraft, wherein the designated aircraft is configured to transmit a pseudo satellite signal to the AUT; simulating motion of the vehicle under the AUT during the tracking/pointing test mode based on either a motion emulation platform attached to the AUT or dynamically adjusting the flight paths of at least the pseudo satellite aircraft; dynamically controlling the flight path of the pseudo satellite aircraft and the other aircraft's flight formation based on the identified and measured main beam lobe(s) of the AUT; and analysing the received RF radiation measured by each of the aircraft for determining the tracking or pointing performance of the AUT.

As an option, the computer-implemented method of the first aspect, wherein in the Antenna radiation pattern measurement phase: analysing the measured RF radiation for dynamically adjusting the flight paths of each of the aircraft to identify and measure at least the main beam lobe (and/or side lobes) of the RF radiation pattern of the AUT; and identifying at least the main beam lobe(s) of the RF radiation pattern of the AUT based on the received RF measurements.

As an option, the computer-implemented method of the first aspect, wherein in the AUT test phase: designating at least one UAV to be a pseudo satellite and a plurality of other UAVs to form a flight formation around the pseudo satellite UAV, wherein the designated UAV is configured to transmit a pseudo satellite signal to the AUT; simulating motion for the AUT during the tracking/pointing test mode based on either a motion emulation platform attached to the AUT or dynamically adjusting the flight paths of at least the pseudo satellite UAV; dynamically controlling the flight path of the pseudo satellite UAV and the other UAV's flight formation based on the identified and measured main beam lobe(s) and/or side lobes of the satellite AUT; and analysing the received RF radiation measured by each of the UAVs for determining the tracking or pointing performance of the AUT.

As an option, the computer-implemented method of the first aspect, wherein for the AUT test phase, the method further comprising dynamically controlling the flight paths of the aircraft to ensure the pseudo satellite aircraft is in the centre of the flight formation of other aircraft, wherein each of the other aircraft are positioned substantially equidistant around the pseudo satellite aircraft.

As an option, the computer-implemented method of the first aspect, wherein the AUT is a phased array antenna, and in the AUT test phase, the method further comprising dynamically controlling the flight formation of the other aircraft around the pseudo satellite aircraft to form a line formation or a 2-dimensional formation of aircraft, and dynamically adjusting the flight paths of the other aircraft to rotate the line formation or the 2-dimensional formation of aircraft around the pseudo satellite aircraft.

As an option, the computer-implemented method of the first aspect, wherein the antenna test system is a satellite antenna evaluation system, the satellite antenna evaluation system comprising the control unit and the plurality of aircraft, wherein each of the plurality of aircraft are unmanned aerial vehicles, UAVs, and the AUT is a satellite AUT, each of the UAVs including a satellite RF sensor module for measuring RF radiation associated with the satellite AUT, the method performed by the control unit further comprising: dynamically controlling the flight paths of each of the UAVs in relation to the AUT based on a set of evaluation test modes, the set of evaluation test modes comprising: an antenna measurement mode of operation, wherein the method further comprising: analysing the measured RF radiation for dynamically adjusting the flight paths of each of the UAVs to identify and measure at least the main beam lobe(s) of the RF radiation pattern of the satellite AUT; and identifying at least the main beam lobe(s) of the RF radiation pattern of the satellite AUT based on the received RF measurements; and a tracking/pointing accuracy test mode of operation, wherein the method further comprising: designating at least one UAV to be a pseudo satellite and a plurality of other UAVs to form a flight formation around the pseudo satellite UAV, wherein the designated UAV is configured to transmit a pseudo satellite signal to the AUT; simulating motion for the AUT during the tracking/pointing test mode based on either a motion emulation platform attached to the AUT or dynamically adjusting the flight paths of at least the pseudo satellite UAV; dynamically controlling the flight path of the pseudo satellite UAV and the other UAV's flight formation based on the identified and measured main beam lobe(s) of the satellite AUT; and analysing the received RF radiation measured by each of the UAVs for determining the tracking or pointing performance of the AUT.

As an option, the computer-implemented method of the first aspect, wherein the set of evaluation test modes further comprising a site survey and calibration test mode, wherein the control unit is configured to perform the steps of: analysing the received measured RF radiation for dynamically adjusting the flight paths of the UAVs to identify and measure possible sources of radio frequency interference in the vicinity of the satellite AUT; and adjusting the RF sensors of each UAV based on the measured RF radiation for taking into account any sources of radio frequency interference when measuring RF radiation associated with the satellite AUT;

As an option, the computer-implemented method of the first aspect, wherein for the tracking/pointing test mode, the control unit performs the step of dynamically controlling the flight paths of the UAVs to ensure the pseudo satellite UAV is in the centre of the flight formation of other UAVs, wherein each of the other UAVs positioned substantially equidistant around the pseudo satellite UAV.

As an option, the computer-implemented method of the first aspect, wherein the AUT is a phased array antenna, and in the tracking/pointing test mode, the control unit performs the step of dynamically controlling the flight formation of the other UAVs around the pseudo satellite UAV to form a line formation or a 2-dimensional formation of UAVs, wherein the control unit is configured to dynamically adjust the flight paths of the other UAVs and by varying steering angles in order to rotate the line formation or the 2-dimensional formation of UAVs around the pseudo satellite UAV.

As an option, the computer-implemented method of the first aspect, further comprising: calculating the pointing accuracy based on using a Bayesian filter, preferably a Kalman filter, more preferably an extended Kalman filter, involving RF measurement results, the dynamics of the positions of the UAVs, control unit, and AUT.

As an option, the computer-implemented method of the first aspect, further comprising: analysing the RF measurements from the UAVs using a decentralised computational structure, wherein the plurality of UAVs is divided into multiple sets of UAVs, wherein the positions of each UAV in a set of UAVs is localised and the RF measurements from each set of UAVs is analysed to form a local estimation of the beam lobe or pointing accuracy, and each of the local estimations associated multiple sets of UAVs are combined to form the final estimation of the beam lobe or pointing accuracy.

As an option, the computer-implemented method of the first aspect, further comprising: using Bayesian estimation techniques to estimate the centre of the main beam based on the measured signal level from each of the plurality of UAVs.

As an option, the computer-implemented method of the first aspect, further comprising: iteratively using Bayesian estimation techniques to dynamically control the flight paths of each of the UAV's in a circular or spiral flight path, which is adjusted in each iteration, to home in on the main beam of the AUT.

As an option, the computer-implemented method of the first aspect, wherein receiving the in-flight position of the aircraft further comprising receiving data representative of global positioning system, GPS, position, heading, altitude and/or attitude of the aircraft.

As an option, the computer-implemented method of the first aspect, further comprising receiving the position of the AUT further comprising receiving data representative of information associated with the position of the AUT.

As an option, the computer-implemented method of the first aspect, wherein the RF sensor module and/or communication sensor interface of an aircraft further comprises at least one from the group of: a receiver; a transmitter; a transceiver; and/or any other communication sensor interface configured for testing the AUT and/or communicating with the control unit.

As an option, the computer-implemented method of the first aspect, wherein each of the plurality of aircraft is configured to: receive dynamic flight path information from the control unit; measure RF radiation associated with the AUT along the received dynamic flight path taken by said each UAV; generate at least one flight path based on available information and communication comprises the received dynamic flight path information, measure RF radiation, dynamic flight path taken; transmit the RF radiation measurements to the control unit; and output said at least one flight path.

As an option, wherein the available information and communication comprise trajectory and RF measurement data associated with each of the plurality of aircraft, wherein the data is time dependent.

As an option, wherein the available information and communication comprise sensor data from one or more cameras and/or from one or more laser-based sensors, preferably LiDAR sensors.

In a second aspect, the present disclosure provides a control station for an antenna evaluation system comprising the control station and a plurality of aircraft, the control station comprising a processor unit, a memory unit, and a communication interface, the processor unit connected to the memory unit and the communication interface, wherein the processor unit, memory unit and communication interface are adapted to implement the computer-implemented method including any of the features and/or steps of the first aspect, modifications thereof, combinations thereof, and/or as herein described.

In a third aspect, the present disclosure provides an antenna evaluation system comprising a control unit/station and a plurality of aircraft, each of the aircraft capable of communicating with the control unit/station and measuring RF measurements from and/or transmit RF signals to an antenna under test, the control unit configured to dynamically control the flight of the plurality of aircraft for measuring RF radiation measurements of the AUT during an antenna performance test and analysing the received RF radiation measurements for determining the antenna performance of the AUT in relation to the antenna performance test.

As an option, the antenna evaluation system of the third aspect, the control unit/station further adapted to implement the computer-implemented method including any of the features and/or steps of the first aspect, modifications thereof, combinations thereof, and/or as herein described.

In a fourth aspect, the present disclosure provides an apparatus comprising a processor unit, a memory unit, and a communication interface, the processor unit connected to the memory unit and the communication interface, wherein the processor unit, memory unit and communication interface are adapted to implement the computer-implemented method including any of the features and/or steps of the first aspect, modifications thereof, combinations thereof, and/or as herein described.

In a fifth aspect, the present disclosure provides a system comprising: a control unit comprising an apparatus according to the fourth aspect; a plurality of aircraft in communication with the control unit; and an antenna under test, wherein the aircraft are configured to perform testing of the AUT under control of the control unit.

In a sixth aspect, the present disclosure provides a computer-implemented method, control station/unit, antenna evaluation system, apparatus, or system of any preceding claim, wherein the aircraft is an unmanned aerial vehicle.

In a seventh aspect, the present disclosure provides a computer-readable medium comprising computer code or instructions stored thereon, which when executed on a processor, causes the processor to the computer-implemented method including any of the features and/or steps of the first aspect, modifications thereof, combinations thereof, and/or as herein described.

In an eighth aspect, the present disclosure provides a system as herein described with reference to the accompanying drawings.

In a ninth aspect, the present disclosure provides a method as herein described with reference to the accompanying drawings.

In a tenth aspect, the present disclosure provides am apparatus as herein described with reference to the accompanying drawings.

In a eleventh aspect, the present disclosure provides an antenna evaluation process as herein described with reference to the accompanying drawings.

In a twelfth aspect, the present disclosure provides an antenna evaluation system as herein described with reference to the accompanying drawings.

In a thirteenth aspect, the present disclosure provides an control station/unit as herein described with reference to the accompanying drawings.

In a fourteenth aspect, the present disclosure provides a reinforcement learning system for use in an antenna evaluation system or process as herein described with reference to the accompanying drawings.

In a fifteenth aspect, the present disclosure provides a computer program product as herein described with reference to the accompanying drawings.

In a sixteenth aspect, the present disclosure provides a computer-implemented method for evaluating satellite terminal antenna, or Antenna Under the Test (AUT), performance, the method comprising: performing a survey for a test site of the AUT and calibrate a payload of at least one aircraft based on the survey; measuring an RF radiation pattern for the AUT using said at least one aircraft; processing data associated with the measured RF radiation pattern for the AUT testing; and testing the AUT by said at least two aircraft mimicking a satellite and/or tracking a main bream direction of the AUT to provide the AUT tracking performance.

In a seventeenth aspect, the disclosure provides a system for evaluating satellite terminal antenna, or Antenna Under the Test (AUT), performance, the system comprising: a control unit and one or more aircraft in communication with the control unit, each aircraft comprises a radio frequency (RF) payload for use in receiving RF measurements from and/or transmit RF signals to the AUT, wherein the payload of at least one aircraft of said one or more aircraft is configured to receive the RF measurements and the transmit RF signals to the AUT simultaneously; the control unit is adapted to apply a set of phases in relation to the received RF measurements from said one or more aircraft, wherein the set of phases comprise (1) a Site Survey and System Calibration phase, (2) an Antenna radiation pattern measurement phase, (3) a data processing and analysis phase, and (4) an AUT testing phase; and the control unit is configured to operate said one or more aircraft in relation to the set of applied phases by mimicking a satellite and/or tracking a main bream direction of the AUT for providing the AUT tracking performance.

In a eighteenth aspect, the disclosure provides a computer-implemented method for measuring partial characteristics of antenna radiation pattern of a pattern varying antenna by tracking multiple beams using one or more aircraft, further comprising: 1) estimating a main beam centre using a beam localization algorithm; 2) locating side lobe area candidates using a circular search algorithm based on the estimated main beam centre; 3) locating side lobe peaks using the beam localization algorithm with initial positions of one or more aircraft defined by angles selected based on the side lobe area candidates; 4) tracking said one or more aircraft in relation to estimated beam centres identified based on the located side lobe peaks; 5) adjusting a steering angle of the pattern varying antenna toward a desired direction to be tested; 6) applying the beam localization algorithm for a set time period to allow said one or more aircraft to find respective beams allocated to each aircraft; 7) locating said one or more aircraft corresponding to the estimated beam centres identified; 8) iterating steps 5), 6), and 7) until all steering angles of interest are tested; and 9) outputting an evaluation corresponding to the antenna radiation pattern, wherein the evaluation comprises estimated beam locations and the partial characteristics comprise measured signal strength from each steering angle.

In nineteenth aspect, the disclosure provides a computer-implemented method for evaluating satellite terminal antenna, or Antenna Under the Test (AUT), performance using one or more aircraft, further comprising: a reinforcement learning (RL) system comprises an agent that interacts with an environment associated with the AUT by receiving at each time step an observation oₜ=[Δx, Δy, ΔPᵣ] characterizing a current state of the environment for said one or more aircraft, the agent selects an action to be performed from a predetermined set of actions, wherein the predetermined set of actions comprises actions selected by the agent based on using a function that is configured to receive as input the observation and an action and to generate a output from said input in accordance with a set of parameters, wherein said input is associated with data from sensors of said one or more aircraft; and the RL system is configured to navigate, based on the actions taken or selected by the agent, said one or more aircraft during at least one phase of AUT evaluation and/or provide waypoints for each aircraft to move to for maintaining accuracy should the AUT main beam direction be mismatched from an initial state during sensor measurement during said at least one phase.

As an option, wherein the function is a recurrent neural network (RNN).

As an option, wherein the set of parameters comprise at least beamwidth degree, signal-to-noise ratio (SNR), and initial relative position in the spherical angle.

As an option, wherein the RL system is a part of a control unit that is adapted to apply the RL system in one or more phases comprising: (1) a Site Survey and System Calibration phase, (2) an Antenna radiation pattern measurement phase, (3) a data processing and analysis phase, and (4) an AUT testing phase.

As an option, wherein the control unit is configured to operate said one or more aircraft in relation to said one or more phases by mimicking a satellite and/or tracking a main bream direction of the AUT for providing the AUT tracking performance.

As an option, wherein said survey for a test site of the AUT and calibrate a payload of at least one aircraft based on the survey further comprising: defining an area of interest for the survey; planning one or more flight paths for said at least one aircraft in the defined area, wherein the defined area is assessed and the payload of said at least one aircraft is calibrated to ensure valid evaluation by a control unit.

As an option, wherein said one or more flight paths are planned dynamically.

As an option, wherein said one or more flight paths are planned to utilize sensor technology and/or predictive algorithms to avoid observable objects on said one or more flight paths.

As an option, wherein said planning one or more flight paths for said at least one aircraft in the defined area further comprising: selecting a portion of the area of interest for repeated flight path planning to obtain further RF measurements.

As an option, wherein the repeated flight path planning is performed for emitter localization or during emitter geolocation.

As an option, wherein said measuring an RF radiation pattern for the AUT using said at least one aircraft further comprising: localising a main beam centre based on a beam localization algorithm; defining a coordinate system corresponding to the main bream centre; and measuring the RF radiation pattern based on the coordinate system using said at least one aircraft taking one or more flight paths.

As an option, wherein the AUT is a pattern varying antenna, further comprises tracking multiple beams of the pattern varying antenna using one or more aircraft comprising: 1) estimating a centre of a main beam using a beam localization algorithm; 2) locating side lobe area candidates using a circular search algorithm based on the estimated main beam centre; 3) locating side lobe peaks using the beam localization algorithm with initial positions of one or more aircraft defined by angles selected based on the side lobe area candidates; 4) tracking said one or more aircraft in relation to estimated beam centres identified based on the located side lobe peaks; 5) adjusting a steering angle of the pattern varying antenna toward a desired direction to be tested; 6) applying the beam localization algorithm for a set time period to allow said one or more aircraft to find respective beams allocated to each aircraft; 7) locating said one or more aircraft corresponding to the estimated beam centres identified; 8) iterating steps 5), 6), and 7) until all steering angles of interest are tested; and 9) outputting an evaluation comprises estimated beam locations and measured signal strength from each steering angle.

As an option, wherein said processing data associated with the measured RF radiation pattern for the AUT testing further comprising: supplying a reference for the AUT testing based on said data associated with the measured RF radiation pattern, wherein the reference defines the placement of one or more sensors a part of the payload on said at least one aircraft.

As an option, wherein said one or more sensors are placed dynamically based on an estimated pointing angle of the AUT.

As an option, wherein said one or more sensors are placed statically based on a position around a direction of a target satellite.

As an option, wherein said testing the AUT by said at least two aircraft mimicking a satellite and/or tracking a main bream direction of the AUT to provide the AUT tracking performance further comprising: applying one or more algorithms to estimate a main beam direction of the AUT based on said data processed prior to the AUT testing.

As an option, wherein said one or more algorithms comprise Kalman filter for estimating the main beam direction.

As an option, wherein the Kalman filter is used in combination with sensor fusion to improve the main beam direction estimation.

The methods and/or process(es) described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features or options may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram illustrating an example antenna evaluation system for use in testing an antenna under test (AUT) according to some embodiments of the invention;

FIG. 2 is a flow diagram illustrating an example antenna evaluation process for use with the antenna evaluation system of FIG. 1 according to some embodiments of the invention;

FIG. 3 is a flow diagram illustrating another example antenna evaluation process for use with the antenna evaluation system of FIG. 1 according to some embodiments of the invention;

FIG. 4a is a schematic diagram illustrating an example of estimating the main beam of an AUT for use with the antenna evaluation system/process(es) as described with reference to any one of FIGS. 1 to 3 according to some embodiments of the invention.

FIG. 4b is a flow diagram illustrating an example pseudo code for a gradient ascent algorithm for estimating the main beam of an AUT for use with the antenna evaluation system/process(es) as described with reference to any one of FIGS. 1 to 3 according to some embodiments of the invention;

FIG. 4c is a graph diagram illustrating an example operation of the gradient ascent algorithm of FIG. 4b when used for estimating the main beam of an AUT for use with the antenna evaluation system/process(es) as described with reference to any one of FIGS. 1 to 3 according to some embodiments of the invention;

FIG. 5a is a schematic diagram illustrating an example centralised feedback system for use with the antenna evaluation system/process(es) as described with reference to any one of FIGS. 1 to 4c according to some embodiments of the invention;

FIG. 5b is a schematic diagram illustrating an example centralised feedback system for use with the antenna evaluation system/process(es) as described with reference to any one of FIGS. 1 to 4c according to some embodiments of the invention;

FIG. 6a is a schematic diagram illustrating an example reinforcement learning system for use with the antenna evaluation system/process(es) as described with reference to any one of FIGS. 1 to 5b according to some embodiments of the invention;

FIG. 6b is a schematic diagram illustrating another example reinforcement learning system based on centralised critic and actor/agent for use with the antenna evaluation system/process(es) as described with reference to any one of FIGS. 1 to 5b according to some embodiments of the invention;

FIG. 6c is a schematic diagram illustrating a further example reinforcement learning system based on centralised critic and decentralised actors/agents for use with the antenna evaluation system/process(es) as described with reference to any one of FIGS. 1 to 5b according to some embodiments of the invention;

FIG. 6d is a schematic diagram illustrating an example GRU unit for use with the reinforcement learning systems of FIG. 6b or 6c according to some embodiments of the invention

FIG. 7a is a graph diagram illustrating example learning transition of parabolic and/or uniform linear array radiation patterns when using the reinforcement learning system of FIG. 6b in the antenna evaluation system/process as described with reference to FIGS. 1 to 5b according to some embodiments of the invention;

FIG. 7b is a schematic diagram illustrating example formation of UAVs around an estimated beam centre when using the reinforcement learning system of FIG. 6c in the antenna evaluation system/process as described with reference to FIGS. 1 to 5b according to some embodiments of the invention;

FIG. 7c is a graph diagram illustrating example learning transition of a parabolic antenna radiation pattern when using the reinforcement learning system of FIG. 6b in the antenna evaluation system/process as described with reference to FIGS. 1 to 5b according to some embodiments of the invention;

FIG. 7d is a table results diagram illustrating example root-mean-square-error (RMSE) for use of reinforcement learning systems of FIGS. 6a, 6b or 6c in the antenna evaluation system/process as described with reference to FIGS. 1 to 5b according to some embodiments of the invention;

FIG. 8a is a schematic diagram illustrating an example AUT tracking/pointing accuracy test set-up with a motion emulator for use with the antenna evaluation system according to some embodiments of the invention;

FIG. 8b is a schematic diagram illustrating an example AUT estimation tracking/pointing accuracy test set-up for use with the antenna evaluation system according to some embodiments of the invention;

FIG. 8c is a schematic diagram illustrating an example AUT tracking accuracy evaluation, in which the de-pointing angle dω is estimated according to some embodiments of the invention;

FIG. 9a is a schematic diagram illustrating an example UAV flight formation for use with the antenna evaluation system according to some embodiments of the invention;

FIG. 9b is a schematic diagram illustrating another example UAV flight formation for use with the antenna evaluation system according to some embodiments of the invention;

FIG. 10 is a schematic diagram illustrating an example AUT tracking/pointing accuracy test set-up with UAVs simulating motion of the AUT for use with the antenna evaluation system according to some embodiments of the invention;

FIG. 11a is a schematic diagram illustrating an example computing system, device or apparatus according to some embodiments of the invention; and

FIG. 11b is a schematic diagram illustrating an example antenna evaluation system according to some embodiments of the invention.

Common reference numerals are used throughout the figures to indicate similar features.

### DETAILED DESCRIPTION

Embodiments of the present invention are described below byway of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The present disclosure provides method(s), apparatus and system(s) for an antenna test system that is configured to dynamically control the flight of a plurality of aircraft (e.g. unmanned aerial vehicles) in relation to an antenna under test (AUT) for performing antenna measurements and analysing the measurements to evaluate the performance of the antenna under test (AUT). The antenna test system may include a control unit or station and at least one aircraft, which has an RF sensor module (e.g. transmitting and/or receiving probe antenna) and communication interface mounted thereon. Preferably the system includes a plurality of aircraft. The aircraft may be, without limitation, for example an unmanned aerial vehicle (UAV), which may be remote controlled in real-time by the control unit to fly around an antenna under test and measure RF radiation of the AUT, which is processed by the control unit for evaluating the performance of the AUT. A UAV may comprise or represent any aircraft, helicopter, quadcopter, drone or any other aircraft or aerial vehicle that is capable of being remotely controlled.

The control unit/station is configured to remotely control the flight paths and/or flight of the aircraft (e.g. UAVs) to perform one or more antenna performance evaluation (APE) procedures using the aircraft mounted with RF sensor modules and communications interfaces. Preferably, to enhance the speed of performing RF measurements and the APE procedures, the control unit may be configured to control a plurality of unmanned aerial vehicles (UAVs), each with antenna testing payload and communications interfaces. The control unit is configured to dynamically control the flight paths of the UAVs whilst performing one or more APE procedures and the like. Example APE procedures include, without limitation, for example calibration of the RF sensor modules/antenna test payload of the UAVs; beam centre determination; Satellite communications On The Move (SOTM); Communications on The Move (COTM); antenna pointing; and/or any other type of APE procedure for testing an AUT using said plurality of aircraft.

The antenna test system may be configured to provide an evaluation methodology of, without limitation, for example Satellite communication On-The-Move (SOTM) antenna measurement and performance in terms of radiation pattern, tracking and pointing accuracy of an antenna under test (AUT) using a system with a ground control unit and multiple UAVs. Although the antenna test system is described herein with reference to SOTM antenna and performance evaluation thereto, this is by way of example only and the invention is not so limited, and the skilled person in the art would understand that the antenna test system may be applied for evaluating the performance of any other suitable antenna or RF antenna and the like such as, without limitation, for example terrestrial antennas, telecommunications and/or mobile base station antennas, SOTM, fixed satellite antennas, and/or any other suitable antenna requiring performance evaluation and the like as the application demands.

There may be one or more APE procedures (also referred to herein as antenna performance tests or APEs) that may include, without limitation, for example one or more from the group of: antenna tracking performance test; antenna pointing performance test; antenna de-pointing performance test; SOTM antenna performance tests; COTM antenna performance tests; Low Earth Orbit antenna performance tests; Medium earth orbit antenna tests; GVF-105 antenna performance tests; any other suitable antenna performance evaluation test in relation to the AUT and the like and/or as the application demands.

The aircraft may comprise or represent any vehicle capable of flying. Examples of aircraft may include, by way of example only but are not limited to, fixed wing aircraft, rotary wing aircraft, helicopter(s), airplane(s), drone(s), unmanned aerial vehicle(s) (UAV(s)), and the like. The control unit and/or station may comprise or represent any computing device capable of controlling and/or communicating with at least one or more aircraft (e.g. UAVs) or a plurality of aircraft or UAV(s) for testing an AUT. The control unit/station may further include the capability of processing RF measurements and/or positions thereof received from said aircraft of the AUT and perform one or more APE tests thereto. Examples of control stations/units may include, by way of example only but are not limited to, computing device, personal computers, laptops, portable computing devices, mobile phone or smart phone, one or more servers, any other computing device and/or computing resource (e.g. cloud computing resources and the like) that may be transported to the test site of the AUT for performing APE and/or testing an AUT and the like. The control unit/station may include a communication interface for communicating over a communication network with remote servers, computing resources and/or cloud computing infrastructure for assisting in processing said RF measurements and/or position information thereof received from the plurality of aircraft during one or more antenna performance tests and the like in relation to the AUT and the like. Although the control unit/station is described herein as being portable and/or transportable, this is by way of example only and the invention is not so limited, the skilled person in the art would appreciate that the control unit/station may be any suitable type of computing device and/or computing resource that is capable of communicating and remotely/dynamically controlling a plurality of aircraft, which receive RF measurements and corresponding positional information for each RF measurement in relation to the AUT, and further capable of processing said received RF measurements and corresponding positional information for each RF measurement during testing of the AUT and in relation to one or more APE tests/antenna evaluation tests, and the like and/or as the application demands.

For example, the antenna test system may be configured for satellite antenna performance evaluation, in which the antenna test system including the control station/unit is configured as an autonomous or semi-autonomous multi-agent system the controls a plurality of UAVs (e.g. a swarm of UAVs) such as, without limitation, for example drones or quadcopters and the like. The multi-agent system of UAVs may be used for de-pointing measurements. An advantage of the antenna evaluation system and/or process(es)/method(s) as described herein according to the invention provides a portable test system such that the test system may be brought to the site of the antenna, rather than the antenna being brought to the test system, thus disrupting location fixed methods of current test facilities (e.g. FORTE) as previously described. Another advantage of the antenna test system and/or method(s)/process(es) thereof as described herein according to the invention provides the capability to measure any COTM antenna including pattern variable antennas due to the mobility of the RF sensor modules on UAVs and the like. The pattern variable antennas include but are not limited to phased array antenna and electronically steerable antenna. A further advantage of the antenna test system and/or method(s)/process(es) thereof as described herein according to the invention provides the capability to evaluate the antennas for new types of satellites and satellite constellations such, without limitation, for example OneWeb (RTM) and SES O3B's mPower (RTM) which operate in non-geostationary configurations such as, without limitation, for example low earth orbit (LEO) and/or medium earth orbit (MEO) configurations. The performance of these types of antennas does not only rely on accurate tracking of a stationary satellite, but also on how well the antenna can track moving satellites meanwhile situated on a moving object. By adding a motion to the plurality of UAVs (e.g. swarm of UAVs) to imitate the trajectory of LEO/MEO satellites, de-pointing measurement for SOTM/COTM antennas oriented to those trajectories will be available. This makes the COTM de-pointing test more accessible and changes the capability of COTM antennas measurement. Thus, an antenna evaluation system using a control station/unit and multiple UAVs enables evaluation of the tracking accuracy of COTM systems, namely, without limitation, for example de-pointing measurement, where it is necessary to have multiple RF sensors on multiple UAVs for measuring the signal strength and the like.

For simplicity, the antenna test system will be described with reference to one or more UAV(s) or a plurality of UAVs, which are a preferred embodiment of the invention. Although a UAV is described herein, this is by way of example only and the invention is not so limited, it is to be appreciated by the skilled person that the antenna test system may be performed with any type of aircraft for performing antenna performance evaluation procedures and the like and/or as the application demands. However, using UAV(s) for performing antenna performance evaluation (APE) procedures provides the advantage of enabling a cost-effective and portable method of testing an AUT in situ, at a test site, and/or at a test site prior to installation and the like and/or as the application demands. As well, a control unit/station may be configured to remotely control the UAVs and receive RF measurements from the plurality of UAVs and automatically dynamically remotely change the flight paths of one or more of the UAV(s) in order to perform multiple antenna performance evaluation (APE) procedures and the like.

Moreover, the entire APE test procedure comprises a set of phases, with each phase comprising further steps. Each phase may be a stage to which the evaluation system performs a part of the APE test on the AUT in a sequential manner. The set of phases or stages comprises 1) a Site Survey and System Calibration phase, performing a survey for a test site of the AUT and calibrate a payload of at least one aircraft based on the survey; 2) an Antenna radiation pattern measurement phase, measuring an RF radiation pattern for the AUT using said at least one aircraft; 3) a data processing and analysis for pointing measurement phase, processing data associated with the measured RF radiation pattern for the AUT testing; and 4) a SOTM/COTM tracking and/or pointing accuracy test phase, testing the AUT by said at least two aircraft are mimicking a satellite and/or tracking a main bream direction of the AUT to provide the AUT tracking performance. In the final phase, during SOTM/COTM tracking accuracy test, the motion of the vehicle could be emulated by a predetermine motion table under the AUT or the aircraft mimicking a satellite should also contain the manoeuvre to include the motion of the vehicle. The phases of the set of phases or stages may be dependent on one another, such as to test the AUT based on one or more UAVs comprises a payload with one or more sensors.

The payload comprises one or more sensors or sensor modules. The payload may be an RF payload or a payload associated with the implementation of one or more cameras and/or LiDAR sensors accompanied by a gamut of technologies used in the field of computer vision. The payload may be configured to transmit and receive data to be processed from and by the control unit. The transmission and reception may be in a simultaneous manner. At least one of the UAVs may therefore be able to communicate with the control unit in such a manner via the payload.

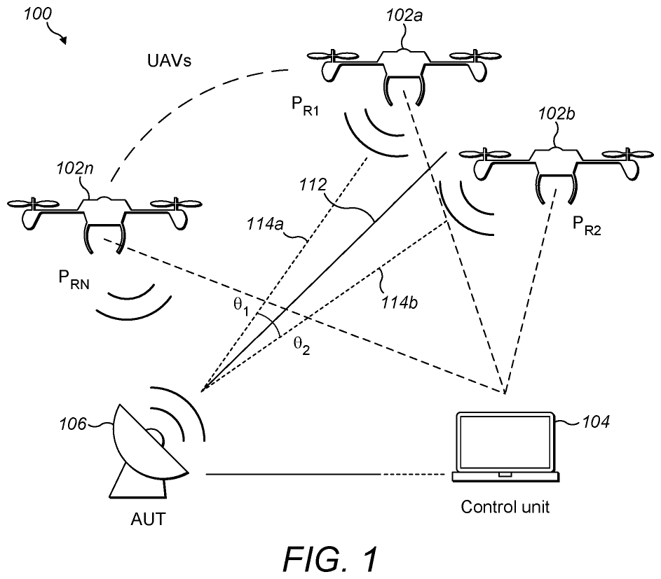

FIG. 1 is a schematic diagram illustrating an example of an antenna test system (e.g. UAV-APE system) 100 in which a plurality of aircraft (e.g. a UAV) 102a-102n with RF sensor modules and/or communications interface are mounted thereto. In this example, there are a plurality of aircraft which are illustrated as UAVs 102a-102n that are controlled by the control unit 104 for performing APE procedures/tests on an AUT 106 (e.g. a satellite antenna under test). Each of the UAVs 102a-102n includes communication and/or RF equipment for use in testing the AUT 106 and communicating with the control unit 104. For example, each of the UAVs 102a-102n may include a communication interface capable of communicating with the control unit 104 and also capable of transmitting/receiving RF signals to/from the AUT 106 when performing APE procedures/tests and the like.

Further, each of the UAVs 102a-102n controlled by the control unit 104 for performing APE procedures/tests on an AUT 106 has onboard computing capacity or comprises one or more computers to facilitate the communication between the UAVs 102a-102n. The communication between the UAVS provides the UAVs 102a-102n with the ability to be controlled in a decentralized manner. Ground station computer for telemetry and measurement data will still be required for the communication.

The communication interface or communication sensor interface may comprise or represent any type of sensor and/or apparatus for testing the AUT 106 during an APE procedure and for communicating with the control unit 104. Examples of communication interface or communication sensor interface may include, by way of example only but are not limited to, one or more RF sensor modules for use in performing APE tests with the AUT 106; one or more of a receiver, a transmitter, and/or a transceiver; a receiver for receiving RF transmissions from the AUT 106; a transmitter configured for transmitting RF transmissions to the AUT 106; a transceiver configured for receiving and/or transmitting RF transmissions to/from the AUT 106; and/or any other communication interface, communication sensor interface, RF sensor module configured for use in testing the AUT 106 during, without limitation, for example an APE procedure.

In this example, FIG. 1 illustrates an example antenna evaluation system 100 with a control unit 106, a plurality of UAVs 102a-102n and an AUT 106. Although this example is described with reference to a plurality of UAVs 102a-102n, this is by way of example only and the invention is not so limited, it is to be appreciated by the skilled person in the art that the antenna testing system 100 may be modified to use a single UAV 102a with the control unit 104 and AUT 106 during APE procedures and the like. Although this is possible, this may increase the time taken and possibly the accuracy of finding the main beam centre and/or retrieving enough RF measurements for performing, without limitation, for example SOTM antenna measurement and performance in terms of the radiation pattern, tracking and pointing accuracy of the AUT 106. The system 100 with the ground control unit 106 and multiple UAVs 102a-102n improves upon this.

Each of the UAVs 102a-102n includes an RF sensor/RF sensor module configured for measuring a radiation pattern of the AUT 106 during flight and is configured to transmit the measured radiation pattern to the control unit 104. The sensors on each of the UAV 102a-102n make measurements in which the flight path and/or locational position of each UAV can be autonomously and dynamically adjusted, via the control station/unit 104 or via on board computer, to position each UAV into the optimal position during the measurement phases or the entire APE procedures. The dynamic adjustment may be performed by the control station/unit 104 based on a feedback algorithm operated by the control station 104 and the RF measurements received by each of the UAVs 102a-102n. The feedback algorithm may be configured to determine, based on received RF measurements, where each of the UAVs 102a-102n should be located around the AUT 106 during the test. The number of UAVs 102a-102n can be increased to increase the accuracy of the AUT performance evaluation of the AUT 106, and/or decreased accordingly.

The control unit/station 104 includes one or more processor units, a memory unit, and a communication interface, where the one or more processor units, memory unit and communication interface are connected together and are configured to: a) control the locational positioning and/or flight paths of each of the multiple UAVs 102a-102n; b) receive the measured radiation patterns from each of the multiple UAVs 102a-102n and calculating the performance of the AUT 106; c) dynamically control, in real-time based on received radiation pattern measurements and site-survey, changes to each UAV's 102a-102n flight path/locational positioning to rapidly and accurately identify and measure the radiation patterns of the AUT 106 including, without limitation, for example measuring radiation patterns of the main beam lobe 112 and/or one or more side lobe(s) 114a and/or 114b and the like of the AUT 106; d) for receiving measuring and calculating the performance, such as, radiation patterns, tracking and/or pointing accuracy of the AUT 106; and e) simulating, if necessary or part of the APE procedure for the AUT 106, motion of the vehicle where AUT is installed 106 via either: i) adjusting the flight paths of the plurality of UAVs 102a-102n to simulate motion of the AUT 106; and/or ii) a motion emulator platform (not shown) which is configured to move the AUT 106 in various orientations/perturbations/vibrations etc., to simulate motion of the AUT 106 in which each of the UAVs 102a-102n may be stationary in flight for calculating the tracking and/or pointing accuracy of the AUT 106.

For example, the APE procedure may be configured to determine the pointing accuracy of the AUT 106 whilst in motion on a vehicle in relation to satellite communications to determine whether the AUT 106 meets a standard set of requirements and/or whether adjustments are necessary, in relation to the AUT 106. In such an APE procedure, one of the UAVs 102a may be configured, by the control unit 104, to simulate a satellite trajectory or orbit using its RF sensors, and the other UAVs 102b-102n may be configured and positioned around the AUT 106 and/or UAV 102a to measure RF signals of the AUT 106 and the like to determine the pointing accuracy of the AUT 106. Alternatively, during the APE procedure, the AUT 106 may be kept motionless whilst the UAVs 102a-102n are instructed to fly over various flight paths simulating the relative real-world motion the vehicle where AUT is installed 106 may experience during satellite communications. For example, the AUT 106 may be an antenna system on a ship, such that the flight paths of the UAV 102a and/or UAVs 102b-102n simulate real-world motion that a ship may experience whilst at sea (e.g. swells, waves, storms, calm conditions). Alternatively, the AUT 106 may be an antenna system on a ground vehicle, such that the flight paths simulate real-world motion the ground vehicle experiences whilst in use (e.g. rough terrain, flat terrain and the like). Simulating the motion of the AUT 106 whilst keeping the AUT 106 motionless means the flight paths of the UAV 102a and also the flight paths of UAVs 102b-102n, which may need to fly in formation around the UAV 102a when it is simulating the motion of the AUT, thus the flight paths of all UAVs 102a-102n may be very erratic.

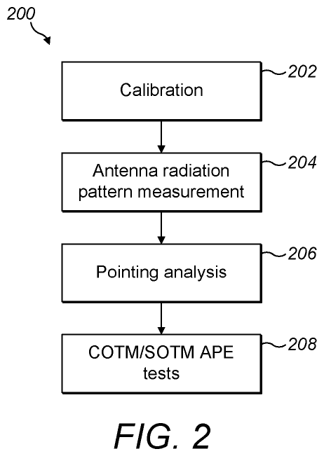

FIG. 2 is a flow diagram illustrating an example antenna evaluation process 200 for use with antenna evaluation system 100 of FIG. 1 according to some embodiments of the invention. For simplicity, reference numerals in relation to FIG. 1 will be used for similar or the same components and/or features and the like. The antenna evaluation process 200, which may be performed and/or controlled by the control unit 104, may include the following steps of: in step 202 calibrating/testing the communication and/or RF sensors of the UAVs 102a-102n and/or performing a site survey of the area around the AUT 106 (e.g. a Site Survey and System Calibration phase); In step 204, performing antenna radiation pattern measurements (e.g. an Antenna radiation pattern measurement phase) by controlling the flight paths of each of the UAVs 102a-102n to fly around the area of the AUT 106, where the RF measurements of the radiation pattern of the AUT 106 are transmitted to the control unit 104, which may be performed in real time. This step starts from main beam localization to fix the boresight, which defines a coordinate system for the radiation pattern mapping. At the beginning of this step, the control unit 104 may dynamically control the flight paths of each of the UAVs 102a-102n to more optimally and/or rapidly find the side lobes and/or main beam lobes of the AUT 106; In step 206, once the control unit 104 receives all necessary RF measurements from the UAVs 102a-102n during step 204, the control unit 104 analyses the RF measurements and performing a pointing analysis and the like for use in SOTM/COTM APE procedures for further evaluating the AUT 106, main beam determination and/or side lobe determination and the like, which may be used in, without limitation, for example COTM/SOTM APE tests and the like (e.g. a data processing and analysis phase for performing an AUT testing phase); In step 208, the control unit 104 controls each of the UAVs 102a-102n to perform one or more COTM/SOTM APE tests (e.g. an AUT test phase) such as, without limitation, for example AUT tracking and/or pointing accuracy tests (e.g. AUT pointing test phase); static tracking and/or pointing accuracy tests of the AUT 106; tracking and/or pointing accuracy tests whilst AUT 106 is in “motion”, where the flight paths of the UAVs may, without limitation, for example be used to simulate motion of the vehicle 106, the AUT 106 may be located on a vehicle/ship/aircraft that is actually in motion, or the AUT 106 is on a motion emulator and the UAVs 102a-102n are stationary hovering in mid-air and the like; in another example, the same procedure may be used for emulating the non-GEO satellite orbit, or dynamically adjusting their placement in real time; the use where the tracking and/or pointing accuracy of the AUT 106 is analysed and determined. The tracking accuracy and/or pointing accuracy of the AUT 106 may be output as a report by the control unit/station 104 to enable, if necessary, the AUT 106 to be maintained, overhauled, re-calibrated, re-designed, adjusted and/or the like to improve its tracking and/or pointing performance.

In one example, when performing the pointing analysis and the like for use in SOTM/COTM APE procedures for further evaluating the AUT, various techniques may be deployed. Once the placement of sensor(s) on the UAVs 102a-102n are complete, depending on whether the placement is fixed or dynamic, the pointing analysis begins. The point analysis provides a de-pointing estimation. Various approaches for obtaining a de-pointing estimation comprising table-matching algorithm, Kalman filter combined with sensor fusion algorithm, and machine learning (ML) based algorithm involving recurrent neural network (the use of recurrent neural network affords sequential information). The table-matching algorithm is the most common method. This is provided as a part of GVF-105 and report from FORTE. Some advantages (Pros) of these approaches can be found in table 1 below.

TABLE 1

| | Pros |
|---|---|
| Table matching | Theoretically simplest and conventional |
| KF & sensor | Requires less number of the sensors |
| fusion | compared to table matching |
| | Established way of sensor fusion |
| ML based | Requires less number of the sensors |
| | compared to table matching |
| | Can carry longer length of the sequential |
| | information compared to KF |

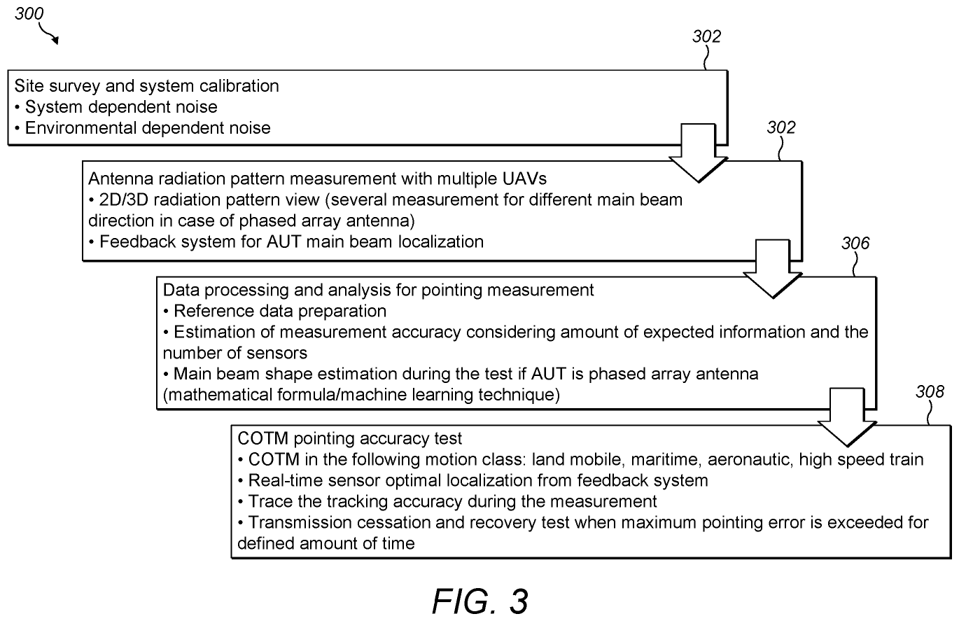

FIG. 3 is a flow diagram illustrating another example antenna evaluation process 300 for use with antenna evaluation system 100 of FIG. 1 and/or for further modifying the antenna evaluation process 200 of FIG. 2 according to some embodiments of the invention. For simplicity, reference numerals in relation to FIG. 1 will be used for similar or the same components and/or features and the like. FIG. 3 illustrates the antenna evaluation process 300 for performing test procedures for evaluating the AUT 106 using the antenna evaluation system 100 of FIG. 1. The test procedures of the antenna evaluation process 300 includes multiple phases or steps including: 1) a Site Survey and System Calibration phase; 2) an Antenna radiation pattern measurement phase; 3) a data processing and analysis for pointing measurement phase; and 4) a SOTM/COTM tracking and/or pointing accuracy test phase. Each phase feeds into a subsequent phase of the test procedure as outlined in FIG. 3. These phases or steps are briefly described. The antenna evaluation process 300, which may be performed and/or controlled by the control unit 104, may include the following steps of:

In step 302, the site survey/system calibration phase, its primary purpose is to assure the test site environment guarantee a valid evaluation. The antenna evaluation system 100 is configured to perform a site survey of the test site/area and/or test airspace around the AUT 106 and system calibration of the RF sensors/communication interfaces of the UAVs 102a-102n, AUT 106 and/or control unit 104 and the like to ensure everything is calibrated and configured for the APE test procedures for testing the AUT 106. The site survey/system calibration phase ensures that the test site is suitable for making measurements in every test environment, given that the antenna evaluation system 100 offers in-situ measurement.

The APE test procedures start from Site Survey and System Calibration phase as in step 302, where the site survey is performed to ensure that the test site is suitable to make measurements from the AUT 106 during subsequent test phases (e.g. steps 304-308). The control unit 104 is configured to control the flight of the plurality of UAVs 102a-102n around the test site in which the AUT 106 is located, in which each of the UAVs 102a-102n performs radiation measurements and transmits the measurements to the control unit 104 for analysis of the test site. The control unit 104 is configured to determine whether the location/test site is safe to perform the evaluation, has less radio interference at UAVs' telemetry and measurement frequency and has an acceptable line of sight (LOS) environment between AUT 106 and each of the multiple UAVs 102a-102n during subsequent test phases/steps 304-308 of the antenna evaluation process 300. In other words, the determination of whether the site is suitable depends on whether the location is safe, have less radio interference at UAVs' telemetry and measurement frequency and have an acceptable LOS environment between AUT 106 and a UAV during the measurement.

For example, by flying the UAVs 102a-102n around the test site/area/airspace for radiation pattern measurement with software digital radio (SDR) at the test frequency and communication frequency, the results can confirm the suitability of the test environment. When strong interference for telematics or operation frequencies are found in the survey, it might be needed to reselect the frequency of the telemetry module of each of the RF sensors of the UAVs 102a-102n to avoid interference and the like. The performance of each RF sensor of each of the UAV 102a-102n shall be measured at the test site to take into account the possibility of variable characteristics of the system due to environmental factors such as temperature and climate. This means that the control unit 104 can then be configured to compensate for these variables during the RF measurement, collection of RF measurements, processing and/or analysis performed in subsequent test phases/steps 304-308 of the antenna evaluation process 300.

The site survey may be required to be conducted for a wide range of the area depending on the requirement of the mission. Once the area to cover is defined, the flight path can be planned accordingly. The planning of the flight path may be done either online or offline. For example, the area of interest can be searched with a single or multiple UAVs based on the shortest amount of time and distance travelled using one or more algorithms associated with flight path planning described herein. The same algorithms may be used in the step for measuring the radiation pattern map. When conducting the site survey, online path planning can be important due to challenging missions or tasks imposed by the UAV or UAVs unilaterally following the path as planned. The area of interest where the mission or tasks are situated may have disturbances to which require online planning after starting the flight. In addition, the online flight planning during the site survey phase permits selective investigation of a certain part of the area more than the others. Online flight planning flexibly re-plans the flight path depending on the situation to cover the area in the shortest path in a cooperative manner

There may also be cases that require more details on the surveyed area. Emitter geolocation is one of the cases. For emitter localization, approaches such as AOA (angle of arrival), TDOA (Time difference on arrival), FDOA (frequency difference of arrival), DRSS (differential received signal strength) may be used. In addition, obstacle identification could be tackled during the site survey/system calibration phase by utilizing computer vision technology and predictive algorithms. In terms of hardware, various types of sensors, in addition to RF sensors, may be deployed as part of the payload. The types of sensors include but are not limited to types of cameras and laser-based sensors such as lightweight LiDARs. The data collected from the various sensor types may be combined or applied separately for obstacle avoidance and flight path planning.

As part of step 302, the site survey/system calibration phase, in effect, provides a measure of the certainty about the decomposed cells in the area of interest using algorithm(s) that can guarantee that all of the information states in the area is above the required certainty without uncovered area. This ensures that the test site is suitable for making measurements in every test environment.

In step 304, the antenna radiation pattern measurement phase, the antenna evaluation system 100 is configured to perform antenna radiation pattern measurement in which the control unit is configured to dynamically control the flight paths of the multiple UAVs 102a-102n over the surveyed area/airspace around the AUT 106. The control unit 104 receives and collects RF measurement and positional data received by the RF sensors and/or location sensors on board the UAVs 102a-102n from AUT 106 and transmitted from UAVs 102a-102n to the control unit 104. 2D/3D radiation pattern views including, without limitation, for example, main beam direction and/or several measurements for different main beam/side lobes direction in case the AUT 106 has a phased array antenna may be generated/analysed from the RF measurements and positional data collected by the UAVs 102a-102n and received by the control unit 104. For the analysis, a multiple beam tracking approach may be used such that the measurements generated/analysed shall be the location and signal strength or antenna gain data of main and side lobes based on different steering angles. The main beam may also be localised using a feedback system/algorithm in which the control unit 104 dynamically controls the flight paths of the UAVs 102a-102n to localise the main beams and the like. For example, the feedback system may be an iterative loop or cycle in which the control unit 104 receives, in real-time, RF measurement samples and positional data associated with each RF measurement sample from the UAVs 102a-102n, analyses the collected RF measurement samples and corresponding positional information, and determines further flight adjustments to the flight paths of each of the UAVs 102a-102n for accurately determining the location and/or direction of the main beam, the main beam radiation patterns/side lobe radiation patterns of the AUT 106 and the like.

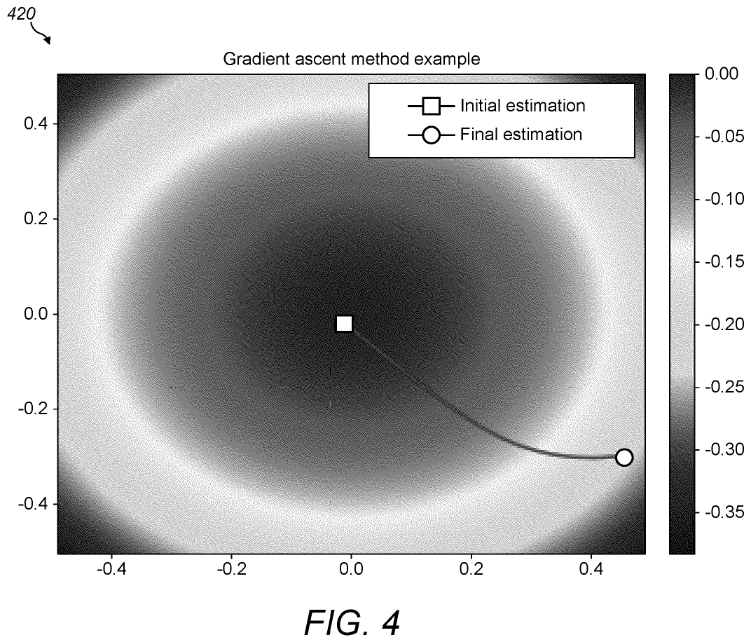

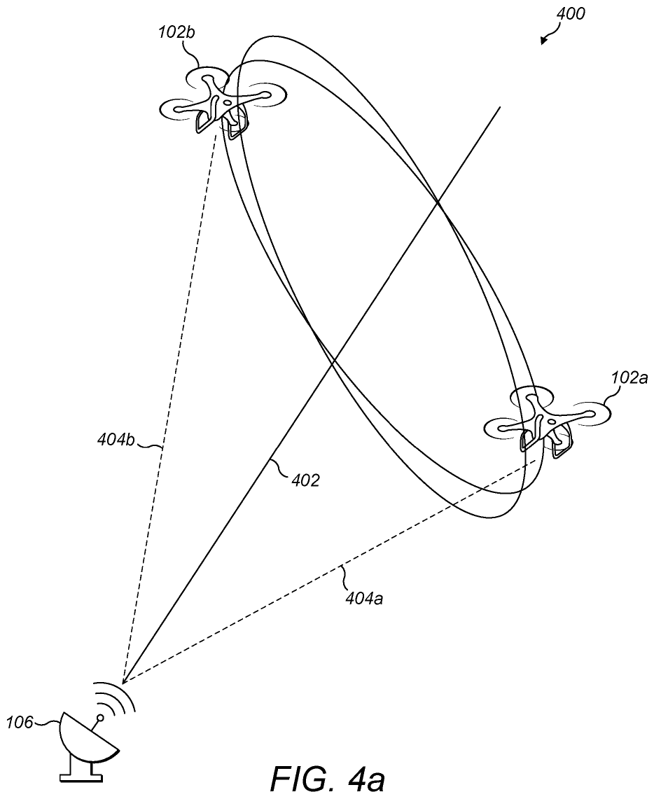

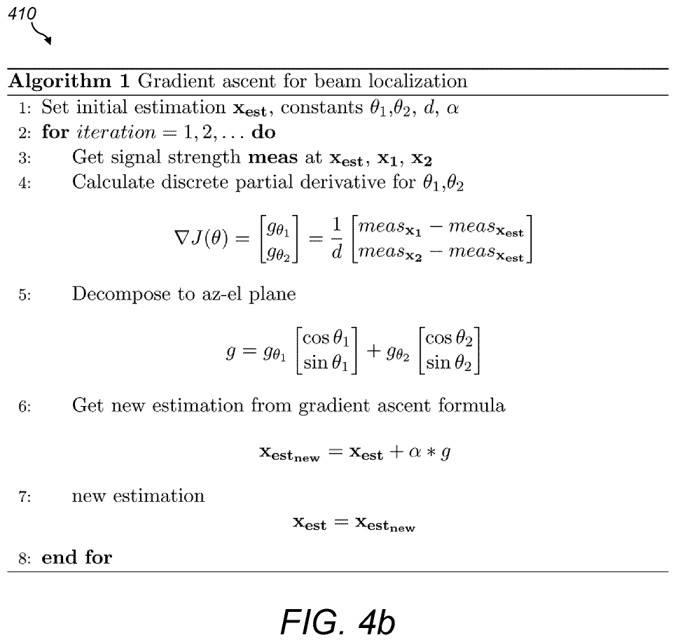

In the antenna radiation pattern measurement phase of step 304 of the antenna evaluation process 300 test procedure it may be possible to execute this measurement phase/step 304 with a minimum of one UAV 102a because it does not require simultaneous measurement from different positions. However, this typically takes a much longer time to perform, where using multiple UAVs 102a-102n the test area/site can be covered and RF measurements were taken at a much quicker pace. The number of UAVs 102a-102n can be dynamically changed depending on the required granularity and resolution of the radiation trace (e.g. 2-D trace only in Horizontal and Vertical plane, 2-D trace using several cuts, 3-D trace low density, 3-D trace high density) and also depending on the time scale for finishing the measurement phase or step 304. Initially, (e.g. one of the first tasks) in the antenna radiation measurement phase is to localize the UAVs 102a-102n with respect to the RF spherical coordinates centered at the AUT 106. This assists in allowing the UAVs 102a-102n to find the main beam centre 112 of the AUT 106. As an example, and illustrated in FIG. 4a, the UAVs 102a-102n may be used to find the main beam centre 112 by having the control unit 104 direct each of the UAVs 102a-102n and/or control the flight paths of each of the UAVs 102a-102n, based on received RF measurements, to move forward or toward an expected centre of the main beam 112 in a circling or spiraling trajectory flight paths that are estimated to be centred on the expected centre of the main beam from the distance of the defined measurement distance (guaranteeing far field, depending on the frequency and AUT size).

Considering the typical symmetricity of the main beam 112 of, without limitation, for example a satellite antenna (or communication antenna) of the AUT 106, the control unit 104 may operate an iterative feedback algorithm/system using Bayesian estimation techniques and/or ML techniques to estimate the centre of the main beam 112 of the AUT 106 based on the measured signal level. This enables the position and orientation of the circle or spiral defining each of the UAV's 102a-102n flight paths to be autonomously and dynamically adjusted by the control unit 104, where flight path adjustments and/or a new flight path are dynamically generated by the control unit 104 and sent to the each of the corresponding UAVs 102a-102n in each iteration of the feedback algorithm/system.

Once the received power levels from the symmetric points around the estimated centre of the main beam 112 become the same, the main beam direction may then be confirmed. Confirming the main bream direction may be done alternatively using other methods described herein. For example, a vector or line may be calculated from the antenna of the AUT 106 going through the centre of the symmetric points and the like. Then, once the main beam 112 has been estimated, the antenna radiation pattern measurement may be performed by the control unit 104 directing the multiple UAVs 102a-102n as required. Determining the centres of any side lobe beams may also be performed based on a similar or the same iterative feedback algorithm used to determine the centre of the main beam 112. For phased array antenna measurement, it may be required to get multiple radiation patterns for different steering angles to use them as reference data for the next tracking accuracy test.

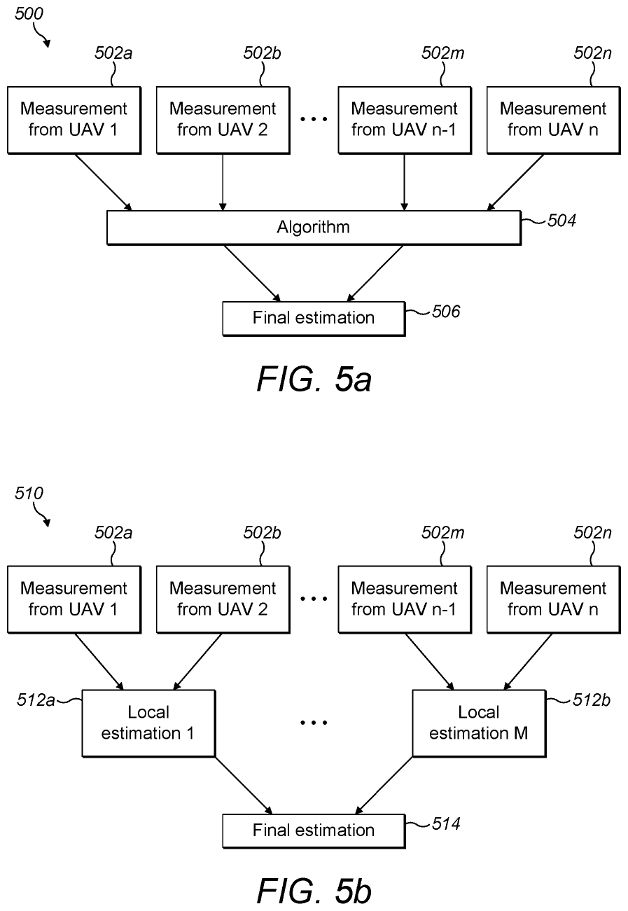

The iterative feedback algorithm may be performed using a centralised or decentralised sensor data fusion structure as illustrated in FIGS. 5a and 5b. For example, the RF measurements received from the UAVs 102a-102n may be centrally processed in which a final main beam estimation is determined, and/or flight paths of the UAVs adjusted. Alternatively, the RF measurements received from sets of groups of UAVs 102a-102b, 102m-102n may be processed for each group of UAVs in a decentralised fashion, for local estimation of main beam location, which may then be combined together for a final main beam estimation and the like. The use of one of the other structures may depend on the computational power and telemetry conditions required.

For example, the iterative feedback algorithm may be based on a gradient ascent algorithm for beam localisation and estimation of the main beam centre of an AUT 106. In another example, a cross-section approach using at least one aircraft (or UAV) or a plurality of aircraft (or UAVs) may include the following steps of: i) Get principal or diagonal cut to estimate radiation pattern; ii) Estimate the beam centre direction by using the symmetricity of the radiation pattern; iii) Get orthogonal cut against the previous cut starting from the cross-section of the two line cuts; iv) Re-estimate the beam centre direction by using the symmetricity of the pattern; and v) Repeat steps iii) to iv) until adequate estimation of main beam and/or beam localisation is obtained. In a further example, a raster scan approach using at least one aircraft (or UAV) or a plurality of aircraft (or UAVs) may include the following steps of: a) get raster scan in the interested region of the test area/site; b) estimate the beam centre based on the raster scan; c) get a second raster scan in the interested region of the test area/site; d) re-estimate the beam centre; and e) repeat c)-d) adequate estimation of main beam and/or beam localisation is obtained. Although various iterative algorithms are described herein, this is by way of example only and the invention is not so limited, it is to be appreciated by the skilled person that other iterative algorithms or non-iterative algorithms may also be applied and/or used in conjunction with those described herein, each other, modifications thereof, combinations thereof and/or as herein described and/or as the application demands for beam localisation, main beam estimation and/or side lobe estimation and the like.

Examples of approaches used to localize the main beam centre, depending on whether the localization is done dynamically, may include but are not limited to the following. The advantages (Pros) of these exemplary approaches are provided in Table 2 below. More detailed explanations for Gradient ascent and RL algorithm are described elsewhere in the application.

TABLE 2

| | Pros |
|---|---|
| Gradient ascent | Well-known approach |
| Cross-section | Less amount of measurement compared |
| | to raster scan |
| Raster scan | Most secure approach since it collects |
| | large amount of data |
| RL | Accurate, robust and time efficient |
| | compared to any other approach |

In further examples, the area to cover to obtain the radiation pattern can be defined once the coordinate system is fixed using one or more above approaches. In the example, it can be defined that the radiation pattern between ϕ_1 to ϕ_2 in azimuth and between θ_1 to θ_2 in elevation angle is required. Then, there can be two ways to define the flight path: off-line planning and on-line planning. In off-line path planning, when the waypoint to visit is defined, trajectory generation can be classified as a travelling salesman problem, which is a well-known problem in the condition where the agent has to visit all of the waypoints in an optimal way. This is normally a NP-hard problem, and there are many existing methods to solve this, e.g., Dijkstra's algorithm and Hungarian algorithm. The computational cost becomes higher when multiple drones are available depending on the environmental topology and the number of the UAVs 102a-102n, although multiple drones can reduce the time. The off-line path planning is thereby simpler and lighter in execution.

On the other hand, on-line algorithm can dynamically change the trajectory planning depending on the status. Doing so can guarantee certainty about the measurement obtained, though it can be challenging to get the UAV to follow the flight path as it is planned beforehand due to some environmental disturbances. Also, there could be cases where further investigation is required in certain positions due to some abnormal measurement as in the site survey phase. The on-line algorithm can replan the trajectory in each timesteps and can provide much more confidence in the measurement. There are several approaches that can be considered to do this, such as the endogenous algorithm proposed by B. Grocholsky or using our novel RL approach, which can be more time-efficient.

The RL approach may be applicable in the situation where the observation provides only partial information regarding the state of the agent, where the RL algorithm needs to solve a Partially Observable Markov Decision Process (POMDP). The POMDP is appearance when the position of the agent w.r.t the beam center is unknown, the representation of the observation of the agent cannot rely on it. Since the environment is not fixed, the interpretation between this state definition and the observation cannot be fixed. What can be predefined and described on this plane are the global coordinate system and the state. The observation definition would therefore be the position and the measured signal strength (oₜ=[x, y, Pᵣ]). The coordinate system would be defined by taking the origin at the initial position of the agent. The drawback of this definition would be when the distance between the initial position of the agent and the goal position is unexpectedly large in implementation. In this case, since the agent will encounter unexperienced observation, it would not be able to make the right decision. Therefore, the observation representation in this work is described as the displacement of the position in 2-dimension and variance of the measured signal strength from the previous time step (oₜ=[Δx, Δy, ΔPᵣ]). In this way, the state representation and interpretation between the state and the observation are generalized. Then, when the observation and hidden stated from the previous time step are given to the actor, the actor generates the displacement as an action for the next time step to the agent as in (1).

a=μ(oₜ,hₜ₋₁) (1)

Also, the reward is defined as

r=ΔPᵣ−0.1 (2)

where ΔPᵣ is the variance of the received power from the previous time step to encourage the agent to move to position expecting higher effective isotropic radiated power (EIRP). Also, −0.1 in (2) works as a punishment as it receives a negative reward every time it steps. This element is to terminate the episode in as small steps as possible. Finally, the termination condition is set as true if the time step reaches the end or the agent reaches the beam center with certain accuracy.

Further, as part of the RL approach, w.r.t meta-reinforcement learning, various environments of Markov Decision Processes (MDPs) are generated at outer loop. The radiation patterns are created based on theoretical models to collect the training dataset. The given meta parameters to change are 3 dB beam width, maximum possible signal to noise ratio (SNR), relative position between initial position of the agent and the beam center. By randomly changing these parameters, an infinite number of MDPs are produced so that the trained system can be guided toward the goal position in any environment. This is further depicted below.

The RL approach, for example, may comprise a neural network architecture in order to solve the POMDP with respect to online flight planning. Specifically, a trained RNN may be deployed, such as a Twin Delay DDPG or TD3 network. During the training, the meta parameters (i.e. 3 dB beam width maximum possible SNR, and initial position to the beam centre) are randomly generated in every episode. Exemplary range of the parameters may be Beamwidth [deg] [3, 6]; SNR [dB] [40, 60]; Initial relative position in spherical angle [[ϕ, θ]][[0,0], [360,0]]. The antenna patterns are simulated based on TE11 circular source model and perfectly symmetrical. One agent is randomly placed w.e.t. the centre of the main beam within the range of ϕ,θ in the spherical coordinate system. The agent makes a measurement at the current location. Based on the observation as it is defined in the previous section, the system is trained to go close to the centre of the main beam. To confirm the performance of the RNN, both networks with and without RNN are tested. The termination accuracy is set to 0.05 degree in x and y direction where x=θ cos ϕ and y=θ cos ϕ.

The deployment of RNN with RL or meta-RL is compared with other methods and showed superior performance in terms of accuracy, robustness, and efficiency in displacement not only in the simulated environment but also in the empirical radiation pattern environment as shown in tables 3 and 4 below. The RL or meta-RL approach or application could be extended to multi beam localization where local maxima exist such as for a varying pattern AUT as described in a separate example.

TABLE 3

| | | | Success | Displacement |
|---|---|---|---|---|
| | RMSE | Std | rate | in success |
| TD3-RNN | 0.059 | 0.272 | 0.982 | 2.817 |
| TD3 | 0.145 | 0.541 | 0.872 | 2.861 |
| GA d = 0.05 | 0.439 | 0.670 | 0.274 | 4.300 |
| GA d = 0.01 | 0.236 | 0.810 | 0.930 | 3.540 |

TABLE 4

| | | | Success | Displacement |
|---|---|---|---|---|
| | RMSE | Std | rate | in success |
| TD3-RNN | 0.056 | 0.091 | 0.921 | 2.812 |
| TD3 | 0.062 | 0.101 | 0.895 | 2.964 |
| GA d = 0.05 | 0.450 | 8.027 | 0.858 | 7.101 |
| GA d = 0.01 | 281.83 | 487.80 | 0.274 | 9.317 |

Table 3 is the evaluation result with empirical radiation pattern. Table 4 is the evaluation result with the theoretical radiation pattern. Both tables compare the gradient ascent approach and TD3 without RNN with TD3 with RNN. Factors such as root mean square error (RMSE), standard deviation (Std), success rate, and displacement in success are considered for the evaluation. The RMSE value with the best robustness observed from the Std reflects the accuracy of the evaluation results. Success rate describes the number of the trial which reached the estimation accuracy less than 0.05. Displacement in success is the total displacement distance required to reach the final position from the trials in success. As such, the RL based antenna beam localization approach was proposed and evaluated, showing superior accuracy.

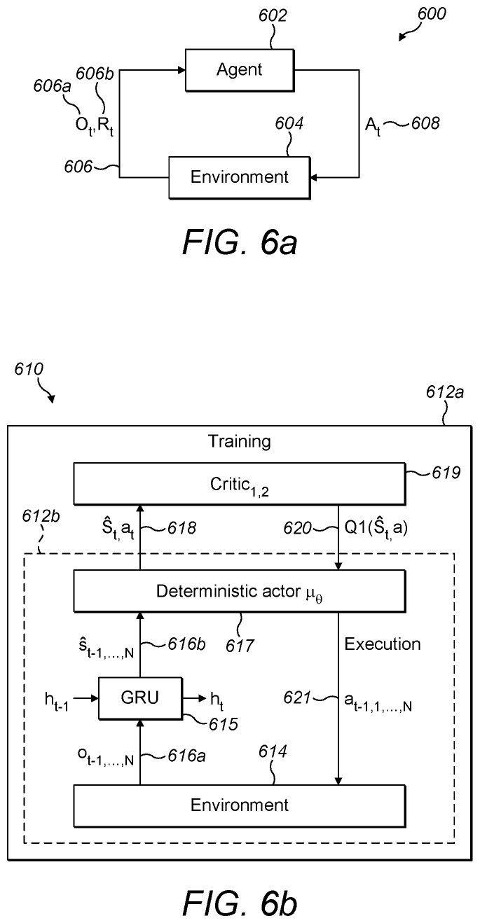

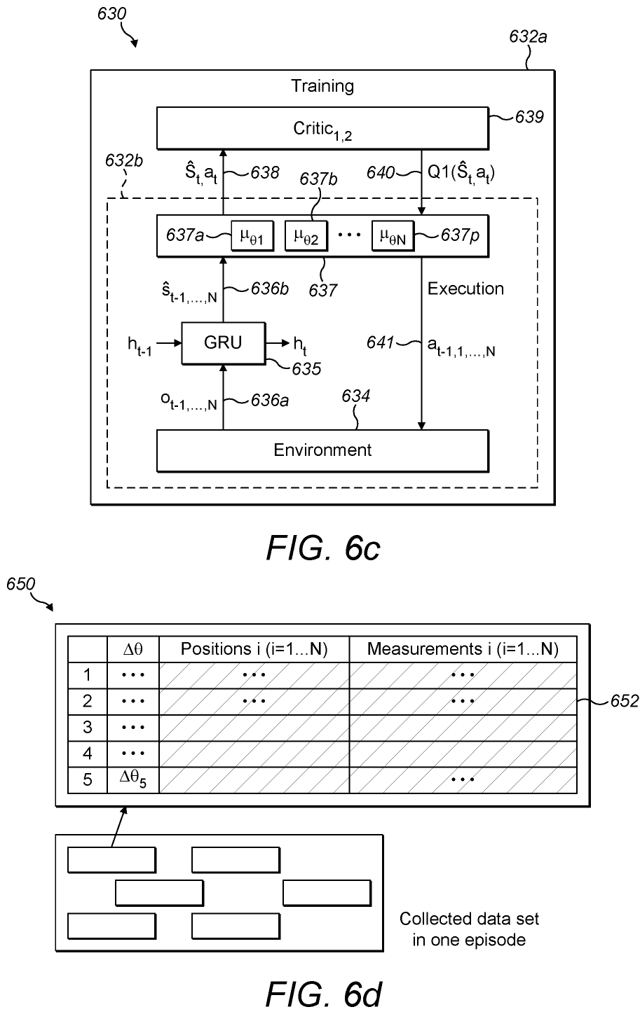

The concept of using RL may also be adapted in other phases in addition to when calculating beam centre or providing estimation thereof and explained in the other sections of the application. For example, RL may be used during the data processing phase before the de-pointing measurement are calculated; or the RL may be applicable in the site survey phase when a certain site condition or circumstance is presented when planning the flight path. Further examples of RL or meta-RL are illustrated, for example, in FIG. 6 and corresponding sections.

In another example, the RL or meta-RL approach may also be used for multiple beam tracking is required when the AUT is a pattern varying antenna (i.e. phased array antenna, electronically steerable antenna). RL works as the RL agent attempts to reach the beam centre by taking the data of the displacement and difference of the received signal strength from the previous timestep iteratively, given the initial estimation of the beam centre. The algorithm showed its benefit in terms of accuracy, robustness, and travelling distance efficiency even when the radiation pattern is in the unexperienced shape. Such use of RL for multi-beam tracking can be considered to provide an individual inventive contribution of its own, even without the certain features described with respect to other phases.

A pattern varying antenna is a type of antenna that changes the radiation pattern depending on the steering angle (direction of the main beam). It can have an infinite number of radiation patterns, and it may not be practical to test all of the possible radiation patterns given the permutation. Currently, there lacks an established method to evaluate this type of antenna. The pattern varying antenna is becoming more popular, especially for COTM terminal antennas, because of the flexibility to change the beam direction without mechanical operation and lightness in weight, thus the need for the meta-RL approach.

The RL evaluation method provides partial information on the radiation pattern by tracking multiple beams in which users are interested. It provides information regarding the transition of the intended beams in terms of the signal strength and their location w.r.t interested steering angles. This method can make sense because what is the most important purpose of the radiation pattern is to have a knowledge of the relation between the main beam and side lobes.

For example, to measure the antenna radiation pattern of a pattern varying antenna by tracking multiple beams using one or more aircraft, the RL evaluation method starts with estimating the centre of the main beam, using a beam localization algorithm such as the ones described herein. Additional following steps 2) to 8) are proposed for obtain the evaluation: 2) locate side lobe area candidates using a circular search algorithm based on the estimated main beam centre; 3) locate side lobe peaks using the beam localization algorithm with initial positions of one or more aircraft defined by angles selected based on the side lobe area candidates; 4) track said one or more aircraft in relation to estimated beam centres identified based on the located side lobe peaks; 5) adjust a steering angle of the pattern varying antenna toward a desired direction to be tested; 6) apply the beam localization algorithm for a set time period to allow said one or more aircraft to find respective beams allocated to each aircraft; 7) locate said one or more aircraft corresponding to the estimated beam centres identified; 8) iterate steps 5), 6), and 7) until all steering angles of interest are tested; and finally, the approach outputs an evaluation corresponding to the antenna radiation pattern, wherein the evaluation comprises an estimated beam location and measured signal strength from each steering angle.

The circular search algorithm of step 2) and shown below as “Algorithm 1” may receive the estimated beam centre as input. For the algorithm, the spherical coordinate system is defined by taking the estimated beam centre as its origin. Firstly, the EIRP measurements are collected around the azimuth axis at the elevation angle of θ in every Δϕ azimuth angle. Then EIRP is measured at the elevation angle of θ+Δθ and the collections of EIRP are compared. When this circular flight path reaches the side lobes, the range of the azimuth angle is observed where the EIRP is higher than the data from the previous circular measurement. Suppose this range is larger than margin M, middle of the range of azimuth angles stored with the current elevation angle as the side lobe area candidate. This process is repeated until the stored candidate number reaches a certain number N.

Algorithm 1 Circular search algorithm for side lobe area localization

| | Input: estimated main beam centre xₑₛₜ |
|---|---|
| | Output: estimated side lobe area Ω_{candidate} |
| | Parameters: radius step Δ0, phase step Δϕ, margin [symbol] , the number |
| | of the beams to be found [symbol] |
| 1: | Initialization: |
| 2: | Ω_{candidate} ← an empty array ; |
| 3: | i ← 0 ; |
| 4: | θᵢ ← 0 ; |
| 5: | while the length of Ω ≤ [symbol] do |
| 6: | for ϕ ← 0 to 360 do |
| 7: | measure signal strength at [ϕ, θᵢ] around xₑₛₜ |
| | Pᵣ[ϕ, θᵢ] ← measured signal strength. |
| 8: | end for |
| 9: | if i ≠ 0 then |
| 10: | calculate judgement array |
| | P_{judge}[ϕ, θᵢ] = Pᵣ[ϕ, θᵢ] − Pᵣ[ϕ, θᵢ₋₁] |
| 11: | collect the ranges where P_{judge}[ϕ, θᵢ] is continuously positive along |
| | ϕ as |
| | ϕ_{range} ← [ϕₛₜₐᵣₜ, ϕ_{end}] |
| 12: | for j ← 0 to the length of ϕ_{range} do |
| | ϕ_{candidate} = ϕ_{range}[j] |
| 13: | if the range of ϕ_{candidate} > [symbol] then |
| 14: | Store the middle of ϕₛₜₐᵣₜⱼ, ϕ_{endj} as ϕ_{middlej}, with θᵢ |
| | Ω_{candidate} add [ϕ_{middlej}, θᵢ] |
| 15: | end if |
| 16: | end for |
| 17: | end if |
| | i ← i + 1 |
| | 0 + 0 + Δ0 |
| 18: | end while |

In deploying the above approach, it is assumed that the UAVs 102a-102n remain in the same beam after the change of the steering angle in step 5. Also, the received signal strength keeps enough signal to noise ratio.

Step 306 involves preparing a reference for the tracking accuracy test, where the reference is used in the following step. It is understood that the preparation of the reference is done by processing and analysing the corrected measurement data. The preparation, therefore, can be different depending on which approach is taken for the tracking accuracy test. The approaches may incorporate exemplary techniques such as RNN based de-pointing measurement training, sensor placement by Monte Carlo simulation or taking the maximum gradient of the radiation pattern. It may also include one or more pre-processing steps that would be applicable to any of the subsequent steps herein described.

For example, based on one or more of these approaches, in step 306, the data processing and analysis for pointing measurement phase, the antenna evaluation system 100 using the control unit 104 analyses the RF measurement samples and corresponding positional data and the like collected, during step 304, from each of the UAVs 102a-102n, for, without limitation, for example preparing reference data, estimation of measurement accuracy, main beam shape estimation and the like for use in COTM/SOTM pointing accuracy APE tests and the like in step 308. In step 306, the control unit 104 may be configured to perform, without limitation, for example reference data preparation; estimation of measurement accuracy considering the amount of expected information and the number of UAVs 102a-102n and/or RF sensors and the like; main beam shape estimation using mathematical formula, machine learning techniques, and/or performed during step 304 if AUT was a phased array antenna and the like.

In the data processing and analysis for pointing phase of step 306, in which the corrected measurement data is processed and analysed to prepare a reference for the tracking and/or pointing accuracy test(s) in the next phase of step 308. To measure the pointing accuracy of the AUT 106, the amount of mis-pointing (de-pointing) is calculated by comparing the ideal difference of the measured signal power at the RF sensor of each of the UAVs 102a-102n based on the obtained radiation pattern information and the real measurement result. To process this estimation faster, it would be proposed to prepare processed dataset in this stage. In the case of a phased array antenna, it is not typically practical to make 3 dimensional measurements from all possible beam direction configurations. However it is better to have antenna reference in order to have the same estimation approach for tracking/pointing accuracy measurements.

When the antenna radiation pattern is known, estimation of measurement accuracy is calculated as a function of the UAV sensor positioning and the number of UAV sensors considering the system characteristics and limitation and expected amount of available information at each point at which the RF radiation pattern was measured. Then, the next test configuration may be proceeded with in step 308.

In one example, under one approach taken for tracking accuracy test, specifically when online adjustment of the UAVs positioning will be made during the tracking accuracy measurement, the measured data needs to be processed instantaneously to generate the action command to make the best sensor placement adjustment. In this case, a reinforcement learning algorithm is proposed, and the system is trained in this phase.

In another example, if the UAVs will be fixed in the same position during the measurement with respect to the main beam, the location to set the UAVs need to be decided in this stage. This could be approximately obtained from the formula stated in GVF-105 or by selecting the highest gradient position on the obtained radiation pattern or Monte-Carlo simulation. In the simulation, several patterns of positioning are evaluated and finally, the sensor placement where the simulation showed the best performance would be chosen.

In both above examples of sensor placement adjustable/non-adjustable of fixed cases, de-pointing angle may be calculated by supervised learning with recurrent neural network (RNN). By taking the input of the placement of the sensors and measured signal strength from them, this neural network may estimate the existing de-pointing angle. The advantage of having RNN in the network is that it allows the network to carry sequential information so that the estimation can be more robust. The training of this approach should be done in this stage.

In the event that the Kalman filter is deployed in step 308, the step 306 may include one or more steps for the preparation of the Kalman filter measurement function. The application and the implementation of the Kalman filter are further described elsewhere in the application.

Some developed machine learning (ML) techniques, including ones described in the examples above, can be used and trained during step 306, the data processing and analysis for pointing measurement phase, in this stage in the simulation. The trained machine learning system may be configured to provide the de-pointing angle in real-time/on-line immediately during step 308, and may also provide waypoints for sensors/UAVs 102a-102n to move to in order to keep the best accuracy when the AUT 106 main beam direction is mismatched from the initial state during the measurement in step 308, an AUT test phase such as, without limitation, for example a COTM/SOTM pointing accuracy test phase. This would be especially beneficial when the amount of the data to look-up is large as in, without limitation, for example the phased array antenna case.

For example, a machine learning, ML, model/system may be built based on inputting a training data set to a machine learning algorithm or technique, the training data set comprising data representative of RF measurement data and corresponding positional information recorded by each aircraft or UAVs 102a-102n in relation to the AUT 106 collected during the antenna radiation pattern measurement phase of step 304. The ML model/system is configured to output an estimate of antenna performance of the AUT associated with an antenna performance test and/or output in-flight trajectory updates for dynamically controlling each of the UAVs 102a-102n for receiving further RF measurements and corresponding positional information based on previously received RF measurements and corresponding positional information from said UAVs 102a-102n during the antenna performance test.

The trained ML model/system may also be configured to provide control/navigation values for UAVs 102a-102n in real-time/on-line immediately during the AUT test phase or COTM/SOTM pointing accuracy test phase 308 and/or provide waypoints for each of the UAVs 102a-102n to move to for maintaining accuracy should the AUT main beam direction be mismatched from an initial state during the RF measurement in the AUT test phase 308. In the AUT test phase 308 when the test is a pointing accuracy test, the RF measurements are RF de-pointing measurements.

As an example, the ML model/system may be, without limitation, for example a reinforcement learning (RL) system derived from an associated RL technique. The RL system may be configured based on a centralised critic and centralised actor/agent. Alternatively or additionally, the RL system may be configured based on a centralised critic and a plurality of decentralised actors/agents. Alternatively or additionally, the RL system is configured based on a decentralised critic and a plurality of decentralised actors/agents. Alternatively or additionally, the RL system may be based on multi-agent reinforcement learning algorithm(s).

In step 308, an AUT test phase such as a COTM/SOTM pointing accuracy test phase, using the results of the data processing and analysis for pointing in step 306, the antenna evaluation system 100 is configured using the control unit 104 to perform, without limitation, for example COTM/SOTM APE tests in at least one of the following motion classes: land mobile, maritime, aeronautic, high speed train, and/or any other vehicle/system that uses an AUT whilst in motion and the like; real-time sensor optimal localisation from feedback system; trace the tracking accuracy during the measurement; transmission cessation and recovery test when maximum pointing error is exceeded for defined amount of time etc. and the like, and/or as the application demands.

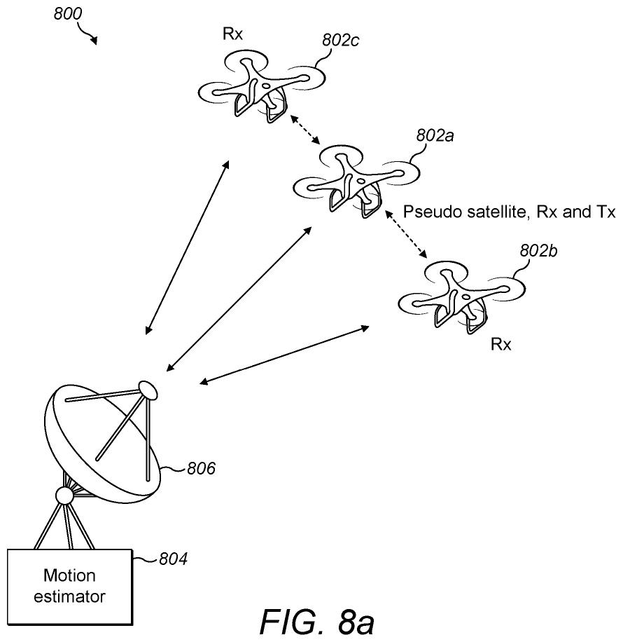

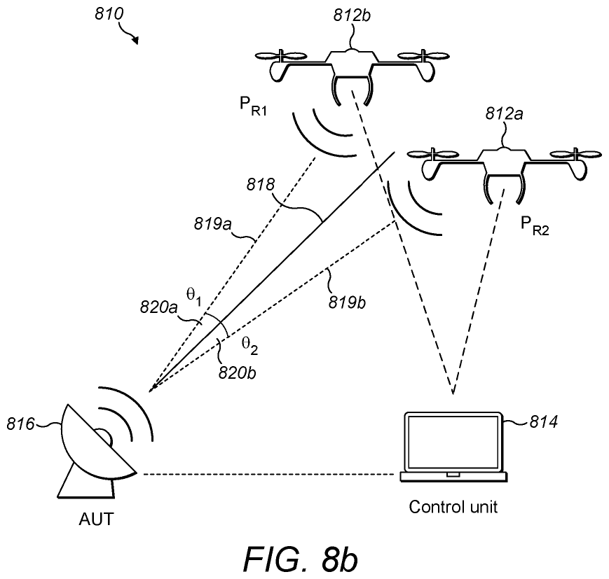

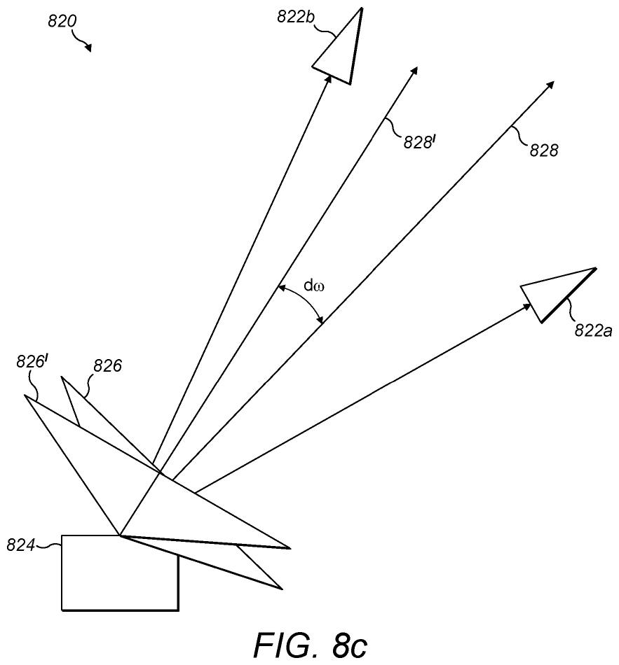

The SOTM/COTM tracking/pointing accuracy test phase is performed in step 308, where in this part of the antenna evaluation test process 300 the AUT 106 may be mounted on a motion emulator, where the RF sensor of one of the UAVs 102a operates as a pseudo satellite, with other UAVs 102b-102n being positioned around the pseudo satellite UAV 102a to measure the radiation/signal strength to estimate the pointing accuracy of the AUT 106 in relation to the pseudo satellite UAV 102a. The SOTM/COTM pointing accuracy of the AUT 106 toward the pseudo satellite UAV 102a is illustrated in FIG. 8a.

Additionally or alternatively, the pointing accuracy can also be tracked by a Bayesian filter involving the dynamics of the system components (e.g. locations of the UAVs 102a-102n and the control unit 104 and the like) and, as outlined in FIG. 8b, where pointing accuracy may be calculated. The measurement function prepared in the previous step may be used for use by the Bayesian filter, or could be prepared ad-hoc in this step. Furthermore, instead of using a motion emulator for simulating motion of the AUT 106, UAVs 102a-102n may be used for simulating motion of the AUT 106 during the tracking/pointing test based on the control unit 104 dynamically adjusting the flight paths of at least the pseudo satellite UAV 102a and the other UAVs 102b-102n, where the flight paths are configured to simulate motion of the AUT 106. The flight paths of the UAVs 102a-102n may be relatively erratic depending on the motion class: e.g. land based vehicle, maritime vehicle, aircraft, high-speed train and/or any type of motion class as the application demands.

For example, the motion emulator may be configured to simulate the vehicle motion of land mobile, maritime, aeronautic, high speed train defined by angular rate, angular acceleration and translational acceleration as proposed by GLOBAL VSAT FORUM (GVF) in GVF-105 Rev 8 “PERFORMANCE AND TEST GUIDELINES FOR TYPE APPROVAL OF ‘COMMS ON THE MOVE’ MOBILE SATELLITE COMMUNICATIONS TERMINALS”. The UAVs 102a-102n are located at the positions defined in step 306 and the test is started. The measurement data is transmitted simultaneously from each of the RF sensors of the UAVs 102a-102n to the control unit 104 and is fused together for calculating the pointing accuracy of the AUT 106. The pointing accuracy calculation may be achieved by comparing the reference data prepared in step 306, the data processing and analysis for pointing measurement phase, with every certain update frequency and based on the de-pointing angle estimation, UAVs 102a-102n could be relocated to another position for improved measurements. Other methods herein described may also be used to attain pointing accuracy calculation.

Furthermore, if a trained machine learning system is prepared in step 306, the data processing and analysis for pointing measurement phase, then the measured data can be treated as input to the trained machine learning system and the position to relocate the sensors and/or de-pointing angle can be extracted from its output in real-time/on-line. As an option, the confidence level of estimation of pointing accuracy can also be tracked by an evaluation algorithm involving the state and characteristics of the system components (e.g. locations of the UAVs and the control unit and signal to noise ratio and the like).

For example, in the AUT test phase 308, when an ML model/system has been trained in the analysis phase 306 and is associated with an antenna performance test, the ML model/system may be used to receive, as input, data representative of real-time RF measurements and corresponding positional information from said UAVs 102a-102n flying around the AUT 106 and, in response, the ML system may output an estimate of the antenna performance associated with the antenna performance test and/or updates or adjustments for dynamically controlling the flight paths of one of more of the UAVs 102a-102n for directing said UAVs 102a-102n to measure further RF measurements and corresponding positional information for estimating the antenna performance. As an example, the trained ML model/system may be configured to provide control/navigation values for UAVs 102a-102n in real-time/on-line immediately during the AUT test phase 308 and/or provide waypoints for UAVS 102a-102n to move to for maintaining accuracy should the AUT main beam direction be mismatched from an initial state during the RF measurement in the AUT test phase 308. When the test is a pointing accuracy test, the RF measurements are RF de-pointing measurements.

Although RL techniques and systems have been described herein, this is by way of example only and the invention is not so limited, it is to be appreciated by the skilled person in the art that other types of ML techniques may be used separately and/or in conjunction with the RL techniques as herein described such as, without limitation, for example supervised ML techniques, semi-supervised ML techniques, unsupervised ML techniques, ML models such as neural networks including without limitation for example recursive neural networks, artificial neural networks, autoencoder/decoder networks and/or any other suitable ML technique that may be used to build a ML model in step 306 for use in estimating performance of the AUT and/or for dynamically controlling the plurality of UAVs 102a-102n for collecting further RF measurements and/or corresponding positional information for more accurately estimating the performance (e.g. tracking/pointing performance) of the AUT 106, modifications thereof, combinations thereto and the like and/or as the application demands.

In step 308, as described, the tracking and/or pointing accuracy of the AUT 106 is analysed and determined. Once step 308 is completed, the tracking accuracy and/or pointing accuracy of the AUT 106 may be output for use by the control unit 104 to indicate, if necessary, how the AUT 106 is to be maintained, overhauled, re-calibrated, re-designed, adjusted and/or the like to improve its tracking and/or pointing performance. This may be in the form of a report and the like that enables an operator or user to adjust, maintain, and/or redesign the AUT 106 such that its tracking and/or pointing performance improves or becomes optimal for that type of AUT 106. Alternatively or additionally, this may be sent to a maintenance unit and/or component, which may, without limitation, for example perform a diagnostic of the AUT 106 and/or adjusts the AUT 106 accordingly.

FIG. 4a is a schematic diagram illustrating an example of estimating the main beam of an AUT for use with the antenna evaluation system/process(es) as described with reference to any one of FIGS. 1 to 3 according to some embodiments of the invention. FIG. 4a is a schematic diagram illustrating an example antenna evaluation system 400. The antenna evaluation system 100 of FIG. 1 and antenna evaluation process 300 of FIG. 3 may be further modified in step. The first task in the Antenna radiation measurement phase is to localize of the UAVs with respect to the RF spherical coordinates centered at the AUT. This assists in allowing the UAVs to find the main beam centre of the AUT. As an example, the UAVs may find the main beam centre by the control unit directing the UAVs, based on received measurements, to move toward the circle trajectory centred on the expected centre of the main beam from the distance of the defined measurement distance (guaranteeing far field, depending on the frequency and AUT size) as shown in FIG. 4a.

Considering the symmetricity of the main beam of a satellite antenna, the control unit may operate an algorithm using some filtering techniques to estimate the centre of the main beam based on the measured signal level. This enables the position and orientation of the circle defining the UAV's flight path to be autonomously adjusted by the control unit and new flight path is dynamically generated by the control unit in each iteration of the algorithm.

Once the received power levels from the symmetric points become the same, the main beam direction is confirmed. Then, antenna radiation pattern measurement is performed as it is required. For phased array antenna measurement, it would be required to get radiation patterns on several planes with different beam steering directions in order to get reference antenna directivity which changes depending on the beam direction for next pointing accuracy test. FIG. 4b describes, by way of example only but the invention is not so limited, a gradient algorithm that may be used for beam localisation and/or main beam centre estimation of the AUT 106.

FIG. 4b is a flow diagram illustrating an example pseudo code for a gradient ascent algorithm for beam localisation and thus estimating the main beam of an AUT for use with the antenna evaluation system/process(es) as described with reference to any one of FIGS. 1 to 3 according to some embodiments of the invention. The gradient ascent algorithm for beam localisation and estimation of the main beam centre of an AUT 106 is one of many examples of an the iterative feedback algorithm/system, as previously described with reference to FIG. 3 in step 304, that may be used to estimate the main beam centre of the AUT 106. The gradient ascent approach follows the gradient of increasing beam strength in order to localize the beam centre and/or determine the main beam centre of the AUT 106. Gradient ascent may be used for iterative optimization by repeating the formula below until convergence.

θ←θ−α∇J(θ) Equation (1)

which is the set of below;

$${θ}_{i} ← {θ}_{i} - α \frac{\partial }{\partial {θ}_{i}} J ( θ ) \qquad Equation ( 2 )$$

where α is gradient descent/ascent step size.

For beam localization, the plane which is orthogonal to boresight is defined by azimuth and elevation axis. Let xₑₛₜ on az-el plane as the current estimation of the beam centre and measure the signal strength from three points: xₑₛₜ, x₁ and x₂, where xᵢ is the position where d separated from xₑₛₜ to θ; direction. When J(G) is considered as the function of radiation pattern, the partial derivative of Equation (2) is discretely obtained from the measurements from the two points: xₑₛₜ and xᵢ. Then the gradient vector is obtained in the plane defined by θ_{1,2}. By decomposing this vector into az-el plane, the gradient ascent, namely new beam estimation x_{est_new}, can be calculated. The gradient ascent for beam localisation methodology/algorithm is provided as follows:

| Algorithm 1 Gradient ascent for beam localization | |
|---|---|
| 1: | Set initial estimation xₑₛₜ, constants θ₁, θ₂, d, α |
| 2: | for iteration = 1, 2, . . . do |
| 3: | Get signal strength meas at xₑₛₜ, x₁, x₂ |
| 4: | Calculate discrete partial derivative for θ₁, θ₂ |
| | $∇ J ( θ ) = [ \begin{matrix}{g}_{{θ}_{1}} \\ {g}_{{θ}_{2}}\end{matrix} ] = \frac{1}{d} [ \begin{matrix}{meas}_{{x}_{1}} - {meas}_{{x}_{est}} \\ {meas}_{{x}_{2}} - {meas}_{{x}_{est}}\end{matrix} ]$ |
| 5: | Decompose to az-el plane |
| | $g = {g}_{{θ}_{1}} [ \begin{matrix}cos {θ}_{1} \\ sin {θ}_{1}\end{matrix} ] + {g}_{{θ}_{2}} [ \begin{matrix}cos {θ}_{2} \\ sin {θ}_{2}\end{matrix} ]$ |
| 6: | Get new estimation from gradient ascent formula |
| | xₑₛₜ_{_{new}} = xₑₛₜ + α * g |
| 7: | new estimation |
| | xₑₛₜ = xₑₛₜ_{_{new}} |
| 8: | end for |

The x_{est_new} may be used by the control unit/station to direct the UAV(s) towards the estimated main beam centre of the AUT 106.

FIG. 4c is a graph diagram illustrating an example operation of the gradient ascent algorithm of FIG. 4b when used for beam localisation and thus estimation the centre of the main beam of an AUT 106 for use with the antenna evaluation system/process(es) as described with reference to any one of FIGS. 1 to 3 according to some embodiments of the invention. In this example, the gradient ascent algorithm described with reference to FIG. 4a is used where the graph diagram of FIG. 4c represents the RF plane. The ‘o’-mark in the graph, indicates the initial estimation for xₑₛₜ and the RF signal measurements received by the control station 104 from the UAVs 102a-102n may be used to estimate x_{est_new} and thus may be used to dynamically update the flight paths of the UAVs 102a-102n for providing further RF signal measurements for further iterations of the gradient ascent algorithm for beam localisation/main beam estimation and the like. The ‘x’ indicates convergence and the final estimation of the main beam centre of the AUT 106. The line between the ‘o’ and ‘x’ may be representative of the flight path direction of the UAVs towards the main beam centre of the AUT 106. This may then be used to determine the main beam directionality and the like as described herein.

Although the gradient ascent algorithm for beam localisation and estimation of the main beam centre of an AUT 106 is described herein, this is one of many examples of an the iterative feedback algorithm/system that may be applied and the invention is not so limited, it is to be appreciated by the skilled person that other iterative algorithms may also be applied and/or used in conjunction with each other and the gradient ascent algorithm for beam localisation. For example, a cross-section approach using at least one aircraft (or UAV) or a plurality of aircraft (or UAVs) may include the following steps of: i) Get principal or diagonal cut to estimate radiation pattern; ii) Estimate the beam centre direction by using the symmetricity of the radiation pattern; iii) Get orthogonal cut against the previous cut starting from the cross-section of the two line cuts; iv) Re-estimate the beam centre direction by using the symmetricity of the pattern; and v) Repeat steps iii) to iv) until adequate estimation of main beam and/or beam localisation is obtained. In another example, a raster scan approach using at least one aircraft (or UAV) or a plurality of aircraft (or UAVs) may include the following steps of: a) get raster scan in interested region of the test area/site; b) estimate the beam centre based on the raster scan; c) get a second raster scan in the interested region of the test area/site; d) re-estimate the beam centre; and e) repeat c)-d) adequate estimation of main beam and/or beam localisation is obtained.

FIG. 5a is a schematic diagram illustrating an example centralised feedback system 500 for use with the antenna evaluation system/process(es) as described with reference to any one of FIGS. 1 to 4c according to some embodiments of the invention. The iterative feedback algorithm as described with reference to FIG. 3 in step 304 and/or FIGS. 4a and 4b may be performed using a centralised sensor data fusion structure as illustrated in FIG. 5a. For example, in FIG. 5a, the RF measurements 502a-502n received from the UAVs 102a-102n may be centrally processed by an iterative algorithm 504 (e.g. as described in step 304 and/or with reference to FIGS. 4a and/or 4b) in which a final main beam estimation 506 is determined, and/or flight paths of the UAVs adjusted to assist in finding/estimating the main beam centre.

FIG. 5b is a schematic diagram illustrating an example decentralised feedback system 510 for use with the antenna evaluation system/process(es) as described with reference to any one of FIGS. 1 to 4c according to some embodiments of the invention. The iterative feedback algorithm as described with reference to FIG. 3 in step 304 and/or FIGS. 4a and 4b may be performed using a decentralised sensor data fusion structure as illustrated in FIG. 5a. For example, in FIG. 5b, the RF measurements 502a-502n received by the control unit/station from sets of groups of UAVs 102a-102b, 102m-102n may be processed for each group of UAVs in a decentralised fashion. Multiple iterative feedback algorithms (e.g. as described with reference to step 304 and/or FIGS. 4a and 4b) 512a-512m may be used for local estimation of the main beam location, where each iterative feedback algorithm 512a only use RF measurements 502a-502b from one of the sets of groups of UAVs 102a-102b and so on. The local estimation algorithms 512a-512b may output a localised estimation of the main beam centre, which are then combined together in a final estimator 514 for outputting a final main beam estimation and the like, and/or updates to the flight paths of the UAVs 102a-102n. The use of one or the other of the centralised or decentralised structures/systems 500 or 510 may be dependent on the computational power and telemetry conditions required.

The data processing and analysis phase 306 of process 300 may be further modified to include the following further steps and/or process(es) that may be performed for use or preparation of the test phase 308 (e.g. AUT test phase) of process 300, which include: analysing the RF measurements and positional information for assisting in antenna performance tests including the antenna tracking and/or pointing tests; performing a tracking/pointing analysis in preparation for one or more of the antenna performance tests associated with tracking/pointing/de-pointing; performing a analysis of the RF measurements and corresponding positional information for determining aircraft positioning in relation to the antenna of the AUT in preparation for one or more of the antenna performance tests; and/or building a machine learning, ML, model/system based on inputting a training data set to a machine learning algorithm or technique, the training data set comprising data representative of RF measurement data and corresponding positional information associated with the AUT collected during the antenna radiation pattern measurement phase, wherein the ML model/system is configured to output an estimate of antenna performance of the AUT associated with an antenna performance test and/or output in-flight trajectory updates for dynamically controlling the aircraft for receiving further RF measurements and corresponding positional information based on previously received RF measurements and corresponding positional information from said aircraft during the antenna performance test:

Based on one or more of the above process(es) having been performed in step 306, the AUT test phase 308 of process 300 may further include the following corresponding process(es): simulating motion of the AUT during one or more antenna performance tests based on one or more of: dynamically controlling the flight paths of the plurality of aircraft UAVs to simulate motion of the AUT; mounting the AUT on a motion emulator for simulating motion of the AUT. The simulated motion is based on simulating motion of one or more vehicle types from the group of: land-based vehicles; maritime vehicles or ships; aircraft; high-speed trains; and any other platform onto which the AUT may be mounted that experiences motion during operation of the AUT.

In the AUT test phase 308 of process 300, when an ML model/system has been built and trained in the data analysis phase 306 and when the trained ML model/system is associated with an antenna performance test, the trained ML model/system may be configured to receive, as input, data representative of real-time RF measurements and corresponding positional information from said aircraft and outputs an estimate of the antenna performance associated with the antenna performance test and/or updates or adjustments for dynamically controlling the flight paths of one of more of the aircraft for directing said aircraft to measure further RF measurements and corresponding positional information for estimating the antenna performance. The trained ML model/system may be configured to provide control/navigation values for aircraft in real-time/on-line immediately during the AUT test phase and/or provide waypoints for aircraft to move to for maintaining accuracy should the AUT main beam direction be mismatched from an initial state during the RF measurement in the AUT test phase.

As an option, in the AUT test phase when the test is a pointing accuracy test, the RF measurements are RF de-pointing measurements. As an option, the ML model/system is a reinforcement learning (RL) system derived from an associated RL technique. As an option, the RL system may be configured based on a centralised critic and centralised actor/agent. As another option, the RL system may be configured based on a centralised critic and a plurality of decentralised actors/agents. As another option, the RL system may be configured based on a decentralised critic and a plurality of decentralised actors/agents. As a further option, the RL system may be based on multi-agent reinforcement learning algorithm(s).

Although reinforcement learning model/system may be described herein, this is by way of example only and the invention is not so limited, it is to be appreciated by the skilled person that any type of suitable trained ML model for use with the test phase 308 in evaluating the performance an AUT may include any suitable type of machine learning technique that is used to build said ML model/system and the like and/or as the application demands.

FIG. 6a is a schematic diagram illustrating an example reinforcement learning system 600 for use with the antenna evaluation system/process(es) as described with reference to any one of FIGS. 1 to 5b according to some embodiments of the invention. In this case, the reinforcement learning system 600, once trained, may be used to determine tracking and/or pointing accuracy during step 308 of the antenna evaluation process 300 as described with reference to FIG. 3. One of the challenges of tracking, pointing, and/or de-pointing measurements for an antenna evaluation system or multi-agent system as described herein is that the system needs to interact with the environment and immediately decide the best next action to measure the tracking/pointing/de-pointing in an as accurate as possible manner. Although it is a natural approach to calculate the existing de-pointing and decide the next action, if de-pointing is calculated from the matching between reference radiation pattern, the computation time will not be sufficiently fast since there is a large amount of candidates on the table. Thus, an antenna evaluation system that is configured to “instantly” or in real-time provide the next action to each of the UAVs desirable. Machine learning techniques may be used/trained to enable multiple RF measurements to be input to the trained ML model and an instantaneous output may be provided that may be used to provide the next action to each of the UAVs and the like. For example, reinforcement learning (RL) is one of the machine learning techniques which is used to train an agent 602 that interacts with a dynamic environment 604 and decide the best action 608 to take from its observation 606a in order to obtain the optimal accumulated reward 606b during the episode.

The diagram 600 describes the concept of RL, which is one of the machine learning techniques which consists of environment 604 and agents 602. Although RL is described herein, this is by way of example only and the invention is not so limited, it is to be appreciated by the skilled person in the art that they are many other machine learning techniques that may also be applicable for use in the antenna evaluation system as described herein and/or as the application demands. In this example, Agents 602 learn and make decisions on which action Aₜ 608 to take at each time step t and state St. The agent 602 receives observations Oₜ 606a from the environment 604 representing the information of new state Sₜ₊₁ of the agent 602 based on the action Aₜ 608 and also a feedback signal, a so called “reward” Rₜ 608b which evaluates the action Aₜ 608. The purpose of the entire learning (training) is to maximize the accumulated reward at the end of the episode. Originally, RL was structured based on Markov decision processes (MDPs). In a most general environment, the interaction from the environment is depending on entire history. On the other hand, MDP, the probability distribution of the response from the environment only depends on the current state as described in:

$$\begin{matrix}{P}_{r} \{ {R}_{t + 1} = r , {S}_{t + 1} = {s}^{′} \vert {S}_{0} , {A}_{0} , {R}_{1} , … , {S}_{t} , {A}_{t} \} \\ = {P}_{r} \{ {R}_{i + 1} = r , {S}_{t + 1} = {s}^{′} \vert {S}_{ι} , {A}_{t} \}\end{matrix}$$

Given the antenna evaluation system as described herein is a multi-agent system when a plurality of UAVs are remotely controlled by the control station, the RL system 600 may be configured to apply the RL technique to a multi-agent system to form a multi-agent RL (MARL) system/algorithm. The MARL system/algorithm can have either centralized, decentralized or centralized training and decentralized execution structure. The centralized structure has only one single agent with large state and action space for all objects to be controlled. The size of the parameters exponentially increases as the number of the objects grows. In the decentralized structure, each object has their own agent, thus the number of the parameters to be learned stay affordable. However this approach generates selfish action and does not suitable for credit assignment. Also, this structure tends to violate the Markov assumption since the other agents are considered as a part of environment though their policy deciding their behaviours vary. Therefore, current trend is to have centralized leaning and decentralized execution so that the Markov assumption can be kept during the training.

In RL, an agent 602 includes the following components: policy, value function and model where policy decides the action of the agent's behaviour, value function represents evaluation of the state and action and model predict the next state from the current state and action. Q-value describes the expected reward as Q^{π}(s,a)=E[R|sₜ=s,aₜ−a] and this value is used to evaluate the policy. To optimize the policy in continuous state-action space, the policy is parameterized with θ and the gradient descent calculated. The objective function is to maximize the return formulated as J(θ)=E_{nθ}[r] where r is total discounted reward. Then the policy gradient is derived as in:

∇_{θ}J(π_{θ})=_{s˜ρ}_{^{π}}_{,a˜π}_{_{θ}}[∇_{θ}log π_{θ}(s,a)Q^{π}^{_{θ}}(s,a)]

There are several approaches to estimate the Q value. One of the common way is called actor-critic method. Q-value is also parameterized and critic is used for estimation of the Q-value function by taking the gradient descent. The actor is trained to optimize the policy parameter θ by taking the estimated gradient from the critic. The actor-critic is extended to deterministic policy gradient (DPG) algorithm where the policies are deterministic as μ_{θ}: S→A with more efficient learning. Deep neural network is normally applied for approximation of policy and critic and this algorithm is called deep deterministic policy gradient (DDPG). Then, the gradient ∇_{θ}J(π_{θ}) can be rewritten as:

∇_{θ}J_{(ρ}_{_{θ}}₎=E_{s˜ρ}_{^{μ}}[∇_{θ}μ_{θ}(s)∇_{θ}μ_{θ}(s)∇ₐQ^{μ}(s,a)|_{a=μ}_{_{θ}}₍ₛ₎]

It had been observed that DDPG tends to overestimate Q-value and end up with slow convergence. To overcome this draw back, twin delayed deep deterministic policy gradient (TD3) may be used, which is motivated by double Q-learning and double DQN. One of the key features of TD3 is “clipped double Q-learning”, where it has two deterministic actors and two corresponding critics. The Q-functions are updated with the minimum target value among these two networks. Also its “delayed update of target and policy networks” feature reduces the variance of value estimation by keeping the update frequency of policy slower than Q-value function update. In addition, “target policy smoothing” was introduced which adds clipped Gaussian noise to the selected action to avoid overfitting to the narrow peaks in the value estimation due to a concern with deterministic policies. The TD3 technique can be successfully applied to MARL.

One of the challenges of the de-pointing measurement is that the observation from the UAVs does not directly represent the state of agent. De-pointing angle needs to be calculated based on the measured signal strength and the measured position. Then, the agent state with respect to the RF sphere around AUT can be calculated. This situation is categorized as Partially Observable Markov decision process (POMDP) which explicitly models environment when the agents no longer have access to the true system state and receive observations instead. Under POMDP, Q-value function is Q(o, a|θ)≠Q(s,a|θ) where o: is the observation. Under this condition, agents need to construct their own state representation. Recently recurrent neural network such as Long Short-Term Memory (LSTM) and Gated Recursive Unit (GRU) has been extended to be used for MARL to address the challenge of partial observably. One of the approaches is using recurrent neural networks (RNN) such as LSTM and GRU which can estimate the hidden state by giving the past sequence of the estimation and new observation. These concepts are applied to estimate/measure de-pointing of the AUT and also produce a trajectory for UAVs so the measurement of the de-pointing angle of AUT may be interactively improved, providing evaluation as accurately as possible.

FIG. 6b is a schematic diagram illustrating an example RL structure 610 for the RL system 600 with centralised critic 619 and actor 617 for use with the antenna evaluation system/process(es) as described with reference to any one of FIGS. 1 to 5b according to some embodiments of the invention. FIG. 6c is a schematic diagram illustrating another example RL structure 610 for the RL system 600 with centralised critic 639 and decentralised actors 637a-637p for use with the antenna evaluation system/process(es) as described with reference to any one of FIGS. 1 to 5b according to some embodiments of the invention. FIG. 6d is a schematic diagram illustrating an example GRU block 650 for use with the reinforcement learning system 610 or 630 of FIG. 6b or 6c according to some embodiments of the invention.

Referring to FIG. 6b, for the RF measurement application, the number of the assigned UAVs may be denoted N (e.g. N=5) and a fully centralized reinforcement learning structure with TD3 is applied to produce the trajectory of the UAVs. The goal of the RL system 610 is to maximize the global reward as a group, e.g. to measure de-pointing angle of AUT as accurate as possible although the algorithm structure is fully centralized. Thus, the structure for this application should have a shared critic 619 rather than having one for each agent. There are two phases, the training phase 612a in which the shared critic 619 is used as described below, and the execution phase 612b, in which the RL system 610 is considered trained based on RF measurements etc., and the shared critic 619 is not used.

The observation 616a from the environment 614 is converted to the estimated state Sₜ 616b via GRU 615 during one episode. The action 621 is chosen from the deterministic actor 617 in each step by providing the state information 616b/618. If it is in the execution phase 612b (e.g. the RL system 610 is considered trained), the critic 619 is not involved and actor 617 keep behaving in the same way. During the training phase 612, the information of previous state, new state, action, rewards are stored in the replay buffer and used for training every time when one episode is done with the accumulated data in the replay buffer. Also, GRU 615 is trained with the buffer for the episode consisting of the observation and real state S. The RL structure 610 may be trained and/or operated during step 306 of the antenna evaluation process 300 based on the RF measurements received from the UAVs in step 304 of process 300 for use in estimating de-pointing/pointing/tracking and/or trajectories the UAVs should take during the COTM/SOTM test phase 308. Once trained on the RF measurements collected in step 304 of process 300, where the RL structure 610 is configured to estimate pointing/de-pointing of the AUT and/or trajectories the UAVs should take during the APE test phase to accurately estimate the pointing/de-pointing of the AUT during training phase 612b. Once trained, in the execution phase 612b, the trained RL structure 610 may be used to calculate the pointing/de-pointing of the AUT and/or trajectories of the UAVs should take during the APE test phase in step 308. The pointing/de-pointing angle is calculated from the correlation between pre-collected radiation pattern and measured signal strength including noise defined by Signal to Noise Ratio (SNR).

Referring to FIG. 6c, as for the centralised RL system 610, for the RF measurement application, the number of the assigned UAVs may be denoted N (e.g. N=5) and the RL system 630 is based on a centralized critic 639 and N decentralised actors 637a, 637b-637n with TD3 applied to produce the trajectory of the UAVs. The goal of the RL system 630 is to maximize the global reward as a group, e.g. to measure de-pointing angle of AUT as accurate as possible although the algorithm structure is partially centralized during the training phase 632a, but decentralised during the execution phase 632b. The structure for this application has a shared critic 639 for all N agents/actors 637a-637n. There are two phases, the training phase 632a in which the shared critic 639 is used to train the decentralised actors/agents 637a-637n as described below, and the execution phase 632b, in which the RL system 630 is considered trained based on RF measurements etc., and the decentralised actors/agents 637a-637n are used whilst the shared critic 639 is not used.

The observation 636a from the environment 634 is converted to the estimated state Sₜ 636b via GRU 635 during one episode. The action(s) 631 are taken from the decentralised actors 637a-637n in each step by providing the state information 636b/638. If it is in the execution phase 632b (e.g. the RL system 630 is considered trained), the critic 639 is not involved and actors 637a-637n keep behaving in the same way. During the training phase 632a, the information of previous state, new state, actions, rewards are stored in the replay buffer and used for training every time when one episode is done with the accumulated data in the replay buffer.

In the RL structure 630, there may be two types of actor input that are considered if the estimated state of all of the agents/actors 637a-637n is shared or only a state of the particular agent/actors of the decentralised actors 637a-637n is assigned for the belonging actor, namely aᵢ=μ_{θ}_{ᵢ}(ŝᵢ) and aᵢ=μ_{θ}_{ᵢ}(ŝ₁, . . . ŝ_{N}). Then, the policy gradient can be written as:

∇_{θ}_{ᵢ}J_{(ρθ}_{ᵢ}₎=E_{s˜ρ}_{^{μ}}[∇_{θ}μ_{θ}(ŝ*ᵢ)∇ₐQ^{μ}(s,a)|ₐ_{ᵢ}_{=μθ}_{ᵢ}_{(ŝ*}_{ᵢ})]

where, ŝ*ᵢ=ŝᵢ or ŝ.

Also, GRU 635 is trained with the buffer for the episode consisting of the observation and real state S. The RL structure 630 may be trained and/or operated during step 306 of the antenna evaluation process 300 based on the RF measurements received from the UAVs in step 304 of process 300 for use in estimating de-pointing/pointing/tracking and/or trajectories the UAVs should take during the COTM/SOTM test phase 308. Once trained on the RF measurements collected in step 304 of process 300, where the RL structure 630 is configured to estimate pointing/de-pointing of the AUT and/or trajectories the UAVs should take during the APE test phase to accurately estimate the pointing/de-pointing of the AUT during training phase 632b. Once trained, in the execution phase 632b, the trained RL structure 630 may be used to calculate the pointing/de-pointing of the AUT and/or trajectories of the UAVs should take during the APE test phase in step 308. The pointing/de-pointing angle is calculated from the correlation between pre-collected radiation pattern and measured signal strength including noise defined by Signal to Noise Ratio (SNR).

The RL structures 610 and 630 may be trained and/or operated based on the following settings during step 306 of the antenna evaluation process 300 based on the RF measurements received in step 304 of process 300. During the pointing/de-pointing test phase in step 308, the pointing/de-pointing angle is calculated from the correlation between pre-collected radiation pattern and measured signal strength including noise defined by Signal to Noise Ratio (SNR).

Thus, as an example, to train at least one of the RL structures 610 or 630 in step 306, the reward R is calculated based on, without limitation, for example the accuracy of the de-pointing estimation (Rₑᵣᵣₒᵣ) and also a factor in order to avoid collision of the UAVs (R_{ca}), where the reward is defined as:

$$\{ \begin{matrix}R = {R}_{error} + {R}_{ca} , & if steps \geq 50 \\ 0 , & otherwise\end{matrix} where$$

$${R}_{error} = - \vert Δ θ \vert$$

$${R}_{ca} = 0.1 \times M .$$

and M is the number of UAVs' pairs of which the distance is closer than 0.10 in any direction between them, for example. Although the reward is defined as described above, this is by way of example only and the invention is not so limited, it is to be appreciated by the skilled person that

In this example, one episode includes, without limitation, for example 1000 steps. In this example, all UAVs are randomly located in the test area and de-pointing measurements are started after 50 steps to give UAVs time to locate themselves to their optimal positions.

Rewards are counted 50 steps after starting de-pointing RF measurements to give agents time to locate UAVs to their optimal positions. The observation O_{t,1 . . . N} is defined as a dataset with the positions of N number of UAVs (e.g. N=5) and measured signal strength (and evaluation angle for ULA/ESA). Referring to FIG. 6d, the observation O_{t,1 . . . N} is stored in the block 650 which includes, in this example, the observations (e.g. position and RF measurement data measured during step 304 of process 300) of the previous N (e.g. N=5) steps and passed to GRU 615/635 as shaded in with diagonal slashed columns/rows 652. That is, N positions and corresponding RF measurements are passed to the GRU 615/635. Then, this data frame of observations (e.g. positions/RF measurements for i=1 . . . N) is processed through GRU 615/635 and current de-pointing estimation is generated as an output of GRU 615/635 (Δθ₅). The state Ŝt is the relative angle between UAVs' position and the estimated main beam direction of the AUT from GRU 615/635. Based on this estimated state Ŝt, the next position to be go in the next time step is calculated from actor 617. As an additional input of observation, the transition from the estimated de-pointing from the previous time step is also implemented to examine if the behaviour information would have an effect on the accuracy.

For the training phase of TD3 network, the episode based on the decision of the actor 617 and dynamic environment is executed and transition data consists of

$$\{ \begin{matrix}R = {R}_{error} + {R}_{ca ,} & if steps \geq 50 \\ 0 , & otherwise\end{matrix}$$

$$where$$

$${R}_{error} = - \vert Δθ \vert$$

$${R}_{ca} = - 0.1 \times M .$$

is collected and stored in the replay buffer. Also, GRU 615/635 is trained every each episode. The training data (e.g. the positions and corresponding RF measurements performed in step 304 of process 300) is accumulated during one episode as a block of data set consists of true de-pointing angle, the positions of N number of UAVs and measured RF signal strength (and evaluation angle for ULA) as are illustrated in GRU block 630 of FIG. 6d.

In this example/scenario or experiment, during the training of the RL structure 610 or 630, de-pointing angle is calculated each steps from the correlation between pre-collected radiation pattern and measured signal strength contains noise defined by Signal to Noise Ratio and UAVs' position data. The best matched angles are assigned as measured de-pointing. As well, the AUT and UAV models are based on Theoretical radiation patterns of a parabolic antenna and an Uniform Linear Array (ULA) are used for the experiments. ULA's radiation pattern varies depending on its steering angle and evaluation angle for ULA is set to 5°. The de-pointing around the evaluation angle is measured during the test. It is assumed that the radiation pattern has a granularity of 0.05° and multiple radiation patterns are available for each steering angle every 0.01° for ULA. The random angular acceleration is added to AUT in each step and it is tested if the movement of AUT is detected accurately from the developed system. It is assumed, for simplicity, that the control unit/station has perfect control of the UAVs to reach the proposed points in the next time step and the Boresight of probe antenna is always directed to AUT.

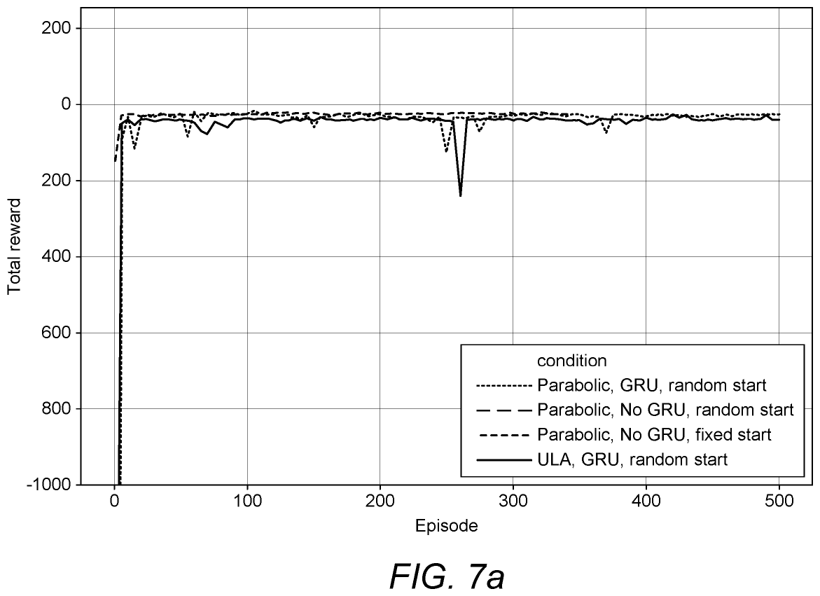

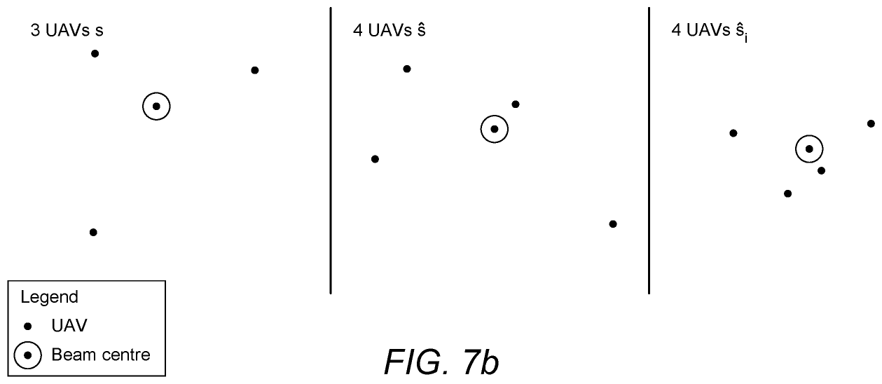

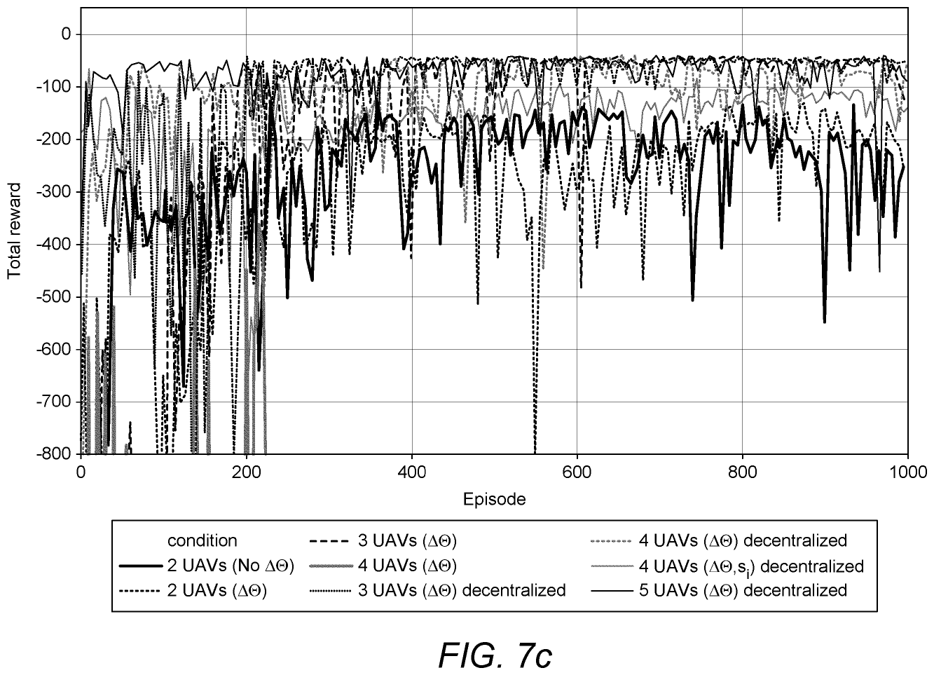

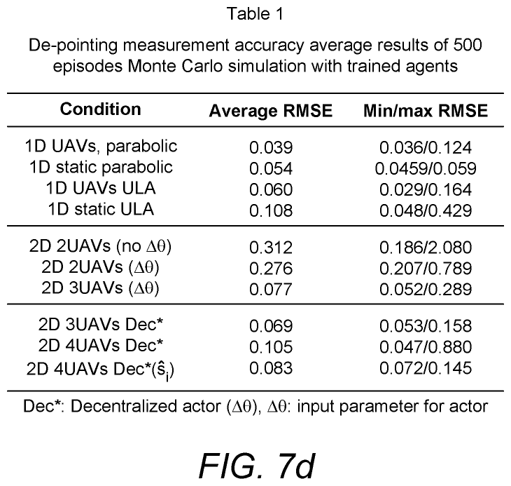

FIGS. 7a and 7c provide some simulated results of the RL system/structure 610 of FIG. 6b for use in antenna evaluation system/process as described with reference to FIGS. 1 to 3 and/or 4a-6b. FIG. 7b is a diagram illustrating the generated UAV formations in 2D using RL structure 630 with decentralised actors. FIG. 7d is a table diagram illustrating a TABLE I of the performance of the RL structures 610/630 for various types of antenna such as parabolic antenna and uniform linear array antenna. In this example, radiation patterns of a parabolic antenna and a Uniform Linear Array (ULA) are used for the various scenarios. The ULA's radiation pattern varies depending on its steering angle and evaluation angle for ULA is set as 5°. The de-pointing around the evaluation angle is measured during the test. It is assumed that the radiation pattern has a granularity of 0.05° and for ULA, multiple radiation patterns is available for each 0.01°. The random angular acceleration is generated during the simulation and it is tested if the movement is detected accurately from the developed system. In the simulations, the perfect control of the UAVs are assumed to reach the proposed points and the Boresight of probe antenna is always directed to the AUT.

FIG. 7a is a graph diagram illustrating example learning transition of RL structure 610 for use with various antennas (e.g. parabolic/ULA) and configurations of the RL structures 610/620 with/without GRU 615/635 and the like and which may be used in the antenna evaluation system/process(es) as described with reference to FIGS. 1 to 5b according to some embodiments of the invention. Firstly the test dimension is limited to 1 direction and the system navigating 2 UAVs is trained for parabolic antenna and ULA. FIG. 7a illustrates the learning transition for parabolic antenna cases and ULA cases with/without GRU 615/635. Essentially, the RL systems 610/630 cannot learn without GRU 615/635 implementation because the system cannot estimate their current state s especially when their initial positions are strongly affected by SNR at low EIRP and it keeps collecting training data based on the wrong estimated state. If the initial position of the UAVs is fixed in a reasonable place, the RL system 610/630 can learn and/or operate without a GRU 610/630 as shown in FIG. 7a. However, this of course would reduce the flexibility of the antenna evaluation system as described herein. Root mean square results (RMSE) from each trained system can be found in FIG. 7d TABLE I, which illustrates a table of de-pointing measurement accuracy average results of 500 episodes Monte Carlo simulation with trained agents. It can be found that more stable performance of the measurement can be found when UAVs are applied compared to having static sensors regardless the amount of de-pointing and the types of antenna. Regardless, the varying amount of de-pointing and type of AUT, the stable performance of the measurements can be obtained when UAVs are applied compared to the system with static sensors since the trained system keeps UAVs adjusting to track the beam of AUT.

FIG. 7c is a graph diagram illustrating example training/learning transition in 2 dimensions of a parabolic antenna radiation pattern when using the reinforcement learning system 630 of FIG. 6c in the antenna evaluation system/process as described with reference to FIGS. 1 to 5b according to some embodiments of the invention. The training transition for RL system 630 with fully centralised RL and decentralised actor system is illustrated in FIG. 7c, where the Δθ describes whether the estimated de-pointing angle is included in the actor's input. There are more fluctuations in the transition in 2 UAVs without Δθ after reaching the maximum total reward though there is no difference observed for maximum achieved reward value. By comparing the measurement accuracy between those two conditions from TABLE I of FIG. 7d, the input information Δθ has advantage to make the trained system 630 more stable in performance. The achievable reward and RSME are effectively improved when 3 UAVs are applied compared to 2 UAVs. In this case, the learning/training transition gets unstable at the beginning. It is expected that the more parameters there is, the harder it is to get conversion as it can be also seen from the result of 4 UAVs.

Also, the example UAV formation from decentralized actor system is shown in in FIG. 7b. The system achieved in the same quality of reward with 3 UAVs compared to fully centralized RL. Both 4 UAVs decentralized networks with the inputs ŝ and ŝᵢ cases converge. However none of them are as accurate as 3 UAVs case. To find out the reason, the state estimation performance from GRU 615/635 was compared between 3 UAVs and 4 UAVs cases, but there was no difference found. It is also noticeable that lower variance is found in RMSE of ŝᵢ case than ŝ case because of R_{CA}. The achievable reward and RSME are effectively improved when 3 UAVs are applied compared to 2 UAVs. In this case, the learning transition gets unstable at the beginning. It is expected that the more parameters there is, the harder it is to get conversion as it can be also seen from the result of 4 UAVs. The system achieved in the same quality of reward with 3 UAVs compared to fully centralized RL. Both 4 UAVs decentralized networks with inputs ŝ and ŝᵢ converges but it is not as stable as 3 UAVs and more reward degradation is found in ŝᵢ case for R_{CA}. No difference was found in the state estimation performance from GRU between 3 UAVs and 4 UAVs.

The RL systems 610 and 630 are examples of applying multi-agent reinforcement learning (MARL) to the problem of estimating de-pointing angle and/or also for adjusting trajectories of UAVs during the step 308 of process 300. The RL systems 610/630 may be trained during step 306 of process 300 and applied to COTM/SOTM test procedures for estimating tracking, pointing, de-pointing of the AUT and, at the same time, controlling the trajectories of the plurality of UAVs flight paths accordingly. Using reinforcement learning for COTM/SOTM tracking is a valid approach for its ability of taking spontaneous action and getting better accuracy. The RL system/structure 610/630 may be further modified for use with the antenna evaluation system/autonomous multi-agent system in measurement methods for COTM/SOTM antennas which includes electronically steerable antenna and the test scenarios for LEO and MEO satellites.

An antenna evaluation system that uses dynamic systems such as multiple UAVs remotely controlled by a control station that controls/adjusts the UAVs flight paths in real-time with the help of machine learning algorithms for adjusting the sensors' (e.g. UAVs with RF sensors/modules) locations during the measurement shows advantages in accuracy and stable performance compared to having static antenna evaluation system. Although there is a challenge of real-time navigation for UAVs/mobile sensors due to the massive amount of reference data (e.g. position data and corresponding RF measurements) to compare, the RL systems 610/630 based on MARL could overcome this issue by generating next actions spontaneously without referencing the data. An antenna evaluation system that incorporates an ML approach may enable COTM/SOTM antenna evaluation possible for many types of antennas including electronically steerable antenna and many new test scenarios for LEO and MEO satellite.

The trained RL system/structures 610/630 of FIG. 6b or 6c may be trained in step 306 of antenna evaluation process 300 and then used in the SOTM/COTM tracking/pointing accuracy test of step 308 of FIG. 300. In this part of the evaluation test procedure, the AUT may be mounted on a motion emulator, where the RF sensor of one of the UAVs operates as a pseudo satellite, with other UAVs being positioned around the pseudo satellite UAV to measure the radiation/signal strength to estimate the pointing accuracy of the AUT in relation to the pseudo satellite UAV. The SOTM/COTM pointing accuracy toward the pseudo satellite UAV is illustrated in FIG. 8a. Alternatively, the AUT may be fixed and the control unit may dynamically direct the flight paths of the UAVs in an erratic manner to simulate the correct motion of the AUT as illustrated in FIG. 8b.

FIG. 8a is a schematic diagram illustrating an example AUT tracking/pointing accuracy test set-up 800 with a motion emulator 804 for use with the antenna evaluation system 100 the antenna evaluation system 100 and/or process(es) 200 or 300 as described with reference to FIGS. 1 to 7c, combinations thereof, modifications thereof and the like, and/or as herein described according to some embodiments of the invention. FIG. 8a is a pointing accuracy test set-up 800 with a plurality of UAVs 802a-802c in which the AUT 806 is mounted on a motion emulator 804 that simulates the vehicle motion of, without limitation, for example at least one of: land mobile, maritime, aeronautic, high speed train defined by angular rate, angular acceleration and translational acceleration as proposed by GLOBAL VSAT FORUM (GVF) in GVF-105 Rev 8 “PERFORMANCE AND TEST GUIDELINES FOR TYPE APPROVAL OF ‘COMMS ON THE MOVE’ MOBILE SATELLITE COMMUNICATIONS TERMINALS”. The UAVs 802a-802c are located at the positions defined in the analysis step 306 for when the COTM/SOTM test phase 308 is started. UAV 802a may emulate a pseudo satellite whilst the other UAVs 1802b and 802c may simply fly in formation around UAV 802a and make RF measurements for determining the tracking/pointing/de-pointing characteristics of the AUT 806 and the like, and/or as described herein with reference to FIGS. 1a to 7c. The UAVs 802a-802c may be remotely controlled by the control station (not shown) to fly to these positions prior to the AUT tracking/pointing tests and the like. The RF measurement data is transmitted simultaneously from each of the RF sensors of the UAVs 802a-802c to the control unit/station and is fused together for calculating, without limitation, for example the pointing accuracy of the AUT 806.

For example, the pointing accuracy calculation may be achieved by comparing the reference data prepared in the previous section with every certain update frequency and based on the de-pointing angle estimation, UAVs 802a-802c could be relocated to the position for improved measurements. However, if a trained machine learning system such as that described with reference to FIGS. 6a to 7c, is prepared in the analysis phase 306 of process 300, for example the reinforcement learning system(s) 600, 610 and/or 630 as described with reference to FIGS. 6a-7c, the measured data can be treated as input to the trained machine learning system and the position to relocate the sensors and/or de-pointing angle can be extracted from its output in real-time/on-line.

For tracking accuracy evaluation, the de-pointing angle dω of the AUT is the parameter of interest, as depicted in FIG. 8c which illustrates an example AUT tracking/pointing accuracy test set-up 820 with a motion emulator 824. The de-pointing angle dω can be estimated by receiving signals from multiple UAVs 822a, 822b. De-pointing measurement is the numerical angular measurement between a target angle 828 (target satellite LOS) of the AUT 826 (ideal AUT) and an actual heading angle 828′ (actual LOS) of the AUT 826′ (real AUT). The AUT can be a communication on the move (COTM) or satellite communication on the move (SOTM) antenna. When the AUT is a COTM antenna, it needs to keep compensating the motion of the vehicle and keep its line of sight at the target satellite. Hence, the state to estimate is the heading angle, or more precisely the main beam direction, and the de-pointing angle can be calculated based on the estimated heading angle. In the considered test setup as depicted in FIG. 8c, the motion of the vehicle is emulated by the motion table 824 underneath the AUT 826 during the measurement and RF receivers mounted on the UAVs 822a, 822b are placed around the target LOS 828 of the AUT 826. De-pointing measurement is an evaluation which assumes that the radiation pattern of the AUT is known and can be used as a reference.

For example, to calculate the de-pointing angle an algorithm using a Kalman filter to estimate the heading angle, or more precisely the main beam direction of the AUT may be used. Such a computer-implemented method that uses a Kalman filter to estimate the heading angle or the main beam direction of the AUT can be considered to provide an individual inventive contribution of its own, even without the certain features described with respect to other phases or the other pointing accuracy test set-ups 800, 810. In particular, when the one or more aircraft is controlled to mimic a satellite and/or track a main bream direction of the AUT when installed on a moving vehicle or a motion emulator, the flight paths of each of the one or more aircraft around the AUT for collecting RF radiation measurements in relation to a tracking accuracy test may be dynamically controlled and an algorithm using a Kalman filter is operated to estimate the de-pointing angle of the AUT. Such a method reduces the effect of noise, for example due to the dynamic of the sensors on the UAVs, and improves the accuracy of the estimation, while the number of UAVs with RF sensors can be kept small.

To estimate an existing de-pointing angle, estimation theory is considered. The estimation accuracy can be improved when some information related to the value of the parameters of interest is known, such as the measurement and system models, measurement data and/or knowledge about initial conditions. The use of Kalman filter algorithms for state prediction in linear systems is known in the art. The estimation of the de-pointing angle is obtained by combining the estimation generated by a dynamic model and a measurement model. The measurement model can be created based on the antenna reference pattern such as, for example, prepared in phase 304 and 306 of process 300 (see FIG. 3, Antenna radiation pattern measurement phase). The dynamic model of the target satellite can be generally described as a Linear Time Invariant Model:

Xₖ₊₁=FXₖ⁺Guₖ+Γwₖ.

wherein F is the state transition matrix, G the control-input matrix to the control vector uₖ, Γ is a noise matrix and ωₖ is the process noise. The measurement mode which describes the relationship between the current state and measurement can be described as:

zₖ₊₁=HXₖ₊₁+vₖ₊₁.

wherein H is the measurement matrix and vₖ is the measurement noise.

The Kalman filter algorithm consists of two stages, a prediction stage and correction stage. In a prediction stage of the Kalman filter, a posteriori state vector of the AUT is calculated based on a priori state vector of the AUT, a control vector and process noise, wherein the state vector represents the heading angle and the control vector represents a displacement of the target satellite during a time step. In a correction stage of the Kalman filter, the posteriori state vector is refined from calculated Kalman gain and innovation using prior state and covariance estimation and a measured signal strength. A measurement function, which can be described as:

zₖ₊₁=h(Xₖ₊₁)+v(k).

with respect to the state of the AUT can be prepared by approximating a pre-measured radiation pattern to a function using Spline interpolation, wherein the Jacobian, which can be described as

$$\frac{\partial h}{\partial X} = {[ \begin{matrix}- \frac{\partial h}{\partial {ω}_{az}} {\vert}_{{ω}_{az} = {ω}_{{az}_{UAV}} - {ω}_{{az}_{AUT}}} \\ - \frac{\partial h}{\partial {ω}_{el}} {\vert}_{{ω}_{el} = {ω}_{{el}_{UAV}} - {ω}_{{el}_{AUT}}}\end{matrix} ]}^{T} .$$

is obtained from a partial derivative of the radiation pattern.

The algorithm further comprises a multisensor fusion technique for combining information and/or RF radiation measurement data from different sources. Multisensor fusion may lead to enhanced data authenticity and availability. It can further improve the reliability and robustness, and increase the confidence as well as extend the spacial and temporal coverage. The multisensor fusion technique may include one or more Kalman filters and RF radiation measurement data obtained from the multiple RF sensor modules as the payload of the one or more aircraft. Different types of fusion architecture may be applied, such as (1) wherein RF radiation measurement data from each RF sensor module is combined and the posteriori state vector is estimated from the fused RF radiation measurement data, (2) wherein the multisensor fusion technique comprises a plurality of Kalman filters equal to the number of RF sensor modules, wherein the posteriori state vectors are centrally fused using a weighted sum, and wherein each Kalman filter uses its own posteriori state vector estimation for the prediction stage in the next time step, or (3) wherein the multisensor fusion technique comprises a plurality of Kalman filters equal to the number of RF modules, wherein the posteriori state vectors are centrally fused using a weighted sum and a fused estimation is used as input for the prediction stage in the next time step. FIG. 8b is a schematic diagram illustrating an example AUT estimation tracking/pointing accuracy test set-up 810 for use with the antenna evaluation system 100 and/or process(es) 200 or 300 as described with reference to FIGS. 1 to 7c, combinations thereof, modifications thereof and the like, and/or as herein described according to some embodiments of the invention. FIG. 8b is also a set-up that estimates pointing accuracy of AUT 806. The confidence level of estimation of pointing accuracy can also be tracked by an evaluation algorithm involving the state and characteristics of the system components (e.g. locations of the UAVs 812a-812b and the control unit 814 and signal to noise ratio and the like radiation pattern if either Monte-Carlo simulation is done in 306 or Kalman filter is used in 308, as illustrated in FIG. 8b, where pointing accuracy may be calculated based on estimating angles θ₁ 820a and θ₂ 820b.

The pointing accuracy of the main beam 818 can also be tracked by a Bayesian filter as herein described (or a Kalman filter as explained in the embodiment according to FIG. 8c) involving the dynamics of the system components (e.g. locations of the UAVs and the control unit and the like) and radiation pattern, as outlined in FIG. 6b, where pointing accuracy may be calculated. It would be also possible to obtain the last estimation from the filter and get an accurate result based on the reference table. If the antenna radiation pattern is not available, as for a phased array antenna case, by interpolating the radiation pattern from the multiple UAVs from different locations, approximated tracking accuracy can be obtained.

The multisensor fusion technique described above may be, for example, deployed in terms of measurement level or measurement level fusion. This approach directly fuses the collected data from the sensors. The measurement data from each sensor are combined, and the state of the target is estimated from the fused measurement data, resulting in an increasingly large dimensional vector. The measurement level fusion process is shown below for 2 sensors:

In another example, state-vector fusion may be used for sensor fusion. It takes a group of Kalman filters and obtains local state estimations. The local states estimations are combined using a weighted sum formulation. The algorithm and covariance matrix are described below:

X_{k|k}=X_{1(k|k)}+P_{1(k|k)}[P_{1(k|k)}+P_{2(k|k)}]⁻¹[X_{2(k|k)}−X_{1(k|k)}] (22)

P_{(k|k)}=P_{1(k|k)}−P_{1(k|k)}[P_{1(k|k)}+P_{2(k|k)}]⁻¹P_{1(k|k)}^{T} (23)

A depiction of the state-vector fusion is shown below:

With respect to the above equation, for sensor 1 and sensor 2, it is possible to use the fused estimation for the prediction. This approach would improve the prediction with uncertain estimation, but it requires more communication or steps. The approach is shown below.

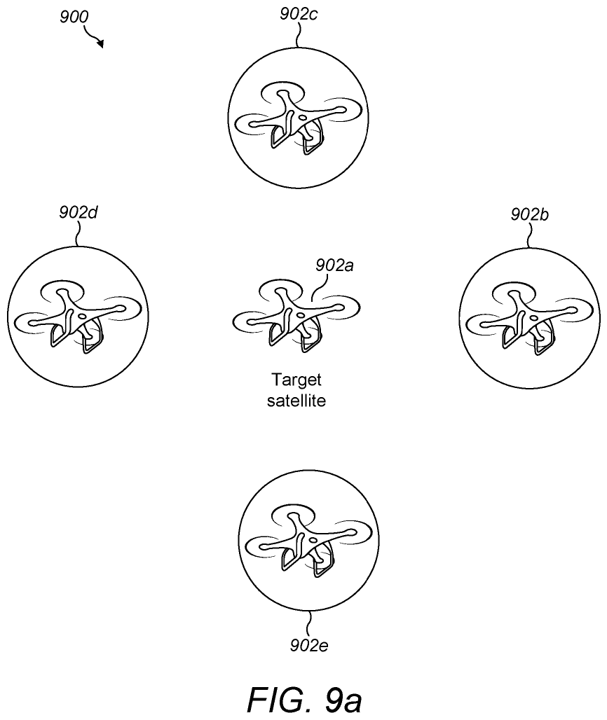

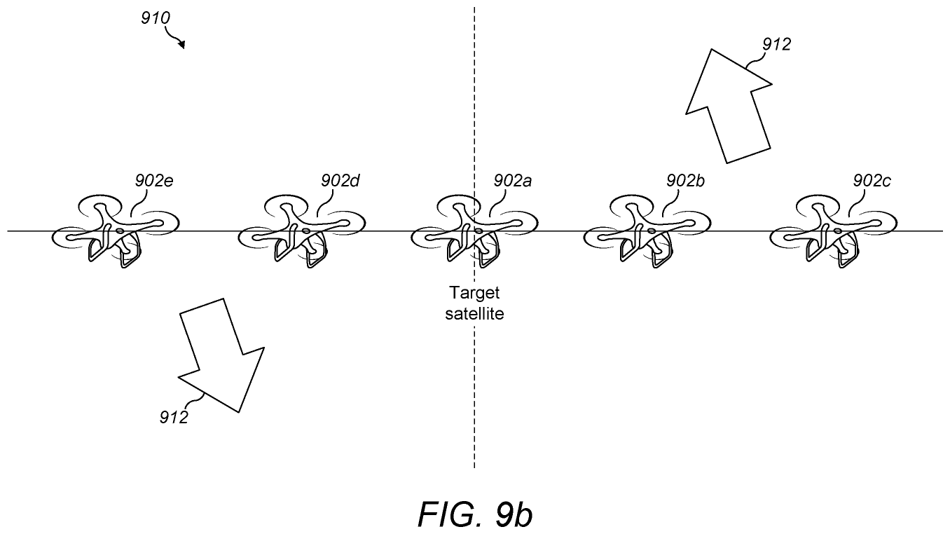

FIG. 9a is a schematic diagram illustrating an example UAV flight formation 900 for use with the antenna evaluation system 100 and/or process(es) 200 or 300 as described with reference to FIGS. 1 to 8c, combinations thereof, modifications thereto, and/or herein described according to some embodiments of the invention. In particular, the UAV flight formation 900 may be used with the pointing accuracy test set-ups 800 or 810 of FIGS. 8a, 8b and/or 8c. FIG. 9a illustrates a basic flight formation set 900 for a plurality of UAVs 902a-902e. In this example, at least four UAVs 902b-902e are used to fly in formation around a target or pseudo satellite UAV 902a in the centre with the other UAVs 902b-902e being remotely controlled and kept at a distance from the pseudo satellite UAV 902a (for example each of the other UAVs 902b-902e is kept substantially equidistant from the pseudo satellite UAV 902a). This distance may be calculated from RF measurement in the analysis phase 306 of the antenna evaluation process 300 and may be based on the number of UAVs 902a-902e surrounding the target/pseudo satellite UAV 902a. The UAV flight formation 900 may also be used during the COTM/SOTM antenna evaluation test phase 308 of antenna evaluation process 300. The control station/unit may dynamically control the trajectories of the UAVs 902a-902e during the RF antenna radiation pattern measurement phase 304 and during the COTM/SOTM antenna evaluation test phase 308 of the antenna evaluation process 300. Alternatively or additionally, the control station/unit may dynamically control the flight path of the pseudo satellite UAV 902a, which mimics a satellite communications with AUT, in which each of the other UAVs 902b-902e are configured to automatically fly in a particular formation 900 and keeping the calculated distance (calculated in the analysis phase 306 of process 300) away from the pseudo satellite UAV 902a. Alternatively or additionally, the control unit/station is configured to dynamically and remotely control in real-time all the UAVs 902a-902e based on RF measurements collected from the UAVs 902a-902e, and is configured to control the flight formation of the UAVs 902a-902e to enable the UAVs to collect the required RF measurements to accurately complete the APE tests (e.g. tracking, pointing, de-pointing evaluation tests of the AUT) in COTM/SOTM test phase 308 of process 300. Also the behaviour of AUT should be assessed when the maximum pointing error is exceeded for a certain amount of time according to the GVF-105.

FIG. 9b is a schematic diagram illustrating another example UAV flight formation 910 for use with the antenna evaluation system 100 and/or process(es) 200 or 300 as described with reference to FIGS. 1 to 9a, combinations thereof, modifications thereto, and/or herein described according to some embodiments of the invention. The flight formation 910 illustrated in FIG. 9b is a line formation or could be 2-dimensional formation where large number of the UAVs are deployed for use in COTM/SOTM test phase 308 of process 300 for phased array antenna pointing measurement. To locate in 2 dimensions, by interpolating the received signal strength from the each sensors of the large number of the UAVs, the approximated radiation pattern can be established instantly. The pre-measured radiation pattern may be obsolete. In the event that the AUT is a phased array antenna that is measured without the information of the antenna directivity, then the optimal flight formation of the UAVs 902b-290e around the target/pseudo satellite UAV 902a and motion might be different as emulated in FIG. 9a. In any case, depending on the estimation, the UAVs 902a-902e may need to adjust their positions to keep their position optimal in terms of estimation performance. Like antenna radiation pattern measurement, the two types of the sensor data architecture can be considered. Also the behaviour of AUT should be assessed when the maximum pointing error is exceeded for a certain amount of time according to the GVF-105.

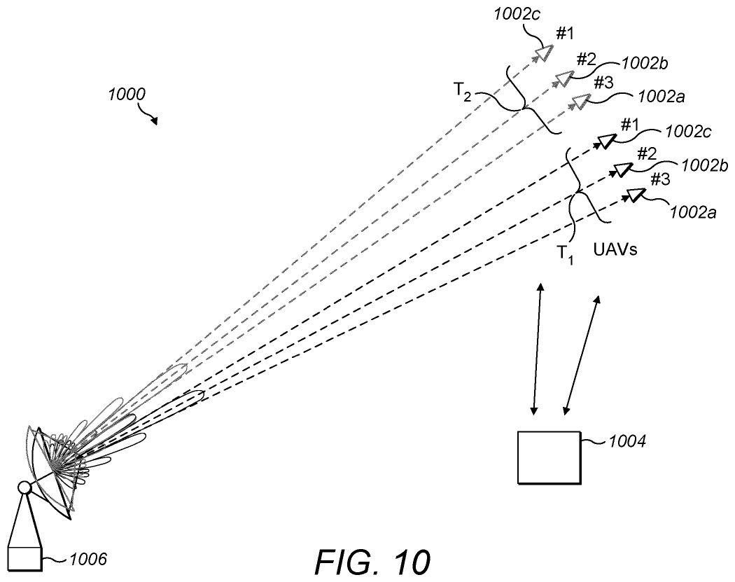

FIG. 10 is a schematic diagram illustrating an example AUT tracking/pointing accuracy test set-up 1000 with UAVs 1002a-1002c simulating motion of the AUT 1006 for use with the antenna evaluation system 100 and/or process(es) 200 or 300 as described with reference to FIGS. 1 to 9b, combinations thereof, modifications thereto, and/or herein described according to some embodiments of the invention. In FIG. 10 the control unit/station 1004 is configured to remotely/dynamically control the UAV 1002a-1002c flight paths are used to emulate motion of a vehicle. Thus, motion of an AUT may be simulated by making the UAVs 1002a-1002c fly around a fixed AUT 1006, where the flight paths of the UAVs 1002a-1002c, which may be erratic, simulate the motion of the vehicle that the AUT 1006 may be mounted on during deployment/operation of the AUT 1006. The UAVs 1002a-1002c may be controlled in this fashion by the control unit/station 1004 in COTM/SOTM test phase 308 of process 300 during, without limitation, for example the tracking/pointing test. The control station is configured to dynamically adjust the flight paths of at least the pseudo satellite UAV 1002a and the other UAVs 1002b-10002c, where the flight paths are configured to simulate motion of the AUT 1006, when the AUT 1006 is mounted on a moving vehicle. The control unit 1004 dynamically controls the flight paths of the pseudo satellite UAV 1002a and the other UAV's 1002c in a flight formation T1 (or flight formations 9090 or 910) based on the identified and measured main beam lobe(s) of the satellite AUT 1006 and the simulated motion flight paths. The control unit/station received RF measurements from the UAVs 1002a-1002c and then analyses as described herein the received RF radiation measured by each of the UAVs 1002a-1002c for determining the tracking or pointing performance of the AUT 1006. Alternatively or additionally, the control unit/station includes a COTM ML model/system that is trained in step 306 of the data analysis phase of process 300 using received RF measurements and corresponding UAV position information collected during the RF measurement phase 304 of process 300 for performing COTM evaluation tests and controlling UAVs during the COTM tests. The COTM ML model/system may be configured to implement the reinforcement systems 600, 610 and/or 630 as described with reference to FIGS. 6a-7c for estimating AUT tracking and/or de-pointing/pointing accuracy and the like, and for controlling trajectories/adjusting trajectories of the UAVs 1002a-1002c based on received RF measurements during step 308 of antenna evaluation process 300 and the like.

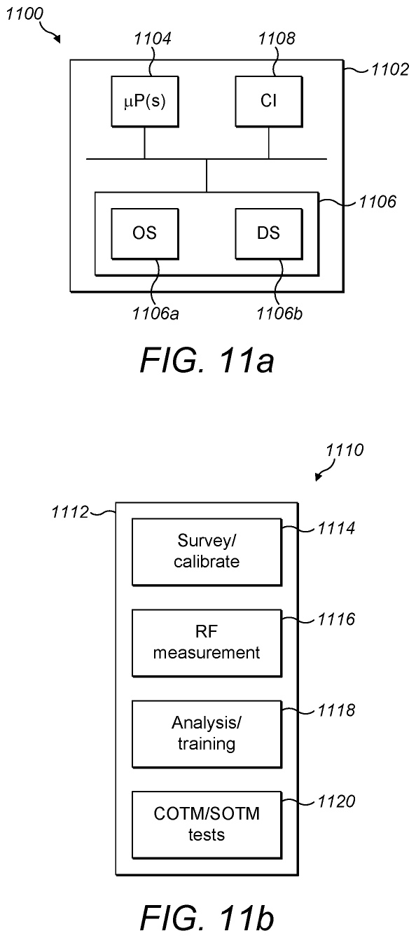

FIG. 11a is a schematic diagram illustrating an example computing system 1100 that comprises at least one computing device 1102 that may be used to implement one or more aspects of the antenna evaluation system, control unit(s), UAV(s), aircraft and/or any other aspects according to the invention and/or includes the methods/process(es)/system(s) and apparatus as described with reference to FIGS. 1a-10. Computing device 1102 includes one or more processor unit(s) 1104, memory unit 1106 and communication interface 1108 in which the one or more processor unit(s) 1104 are connected to the memory unit 1106 and the communication interface 1108. The communications interface 1108 may connect the computing device 1102 to one or more other device(s), AUT, UAV(s), one or more sensor(s), RF station(s), external or cloud storage or processing system(s) and the like. The memory unit 1106 may store one or more program instructions, code or components such as, by way of example only but not limited to, an operating system 1106a for operating computing device 1102 and a data store 1106b for storing additional data and/or further program instructions, code and/or components associated with implementing the functionality and/or one or more function(s) or functionality associated with the antenna evaluation system, control unit/station and/or functionality of one or more of the antenna evaluation system, control station/unit, UAV(s) and the like, method(s), process(es), any other functionality of the aircraft/UAV, APE procedures as described with reference to FIGS. 1a-10, combinations thereof, modifications thereof and/or as described herein and the like according to the invention.

The memory unit may include a computer-readable medium with data or instruction code, which when executed on the processor unit, causes the processor unit to implement the functionality of the antenna evaluation system, control unit/station, process(es)/method(s) as described herein and/or modifications thereof. The apparatus or computing device may be further configured to implement the functionality of the antenna evaluation system, control station/unit, UAV/aircraft, a user interface as described herein and/or modifications thereof.

FIG. 11b is a schematic diagram illustrating an example antenna evaluation system 1110 with a control unit 1112 configured for controlling one or more UAVs according to some embodiments of the invention. The control unit/station 1112 for controlling one or more aircraft/UAV and/or a plurality of aircraft/UAV for performing an APE test procedure and/or as described herein. The control station/unit 1112 may include a Site Survey and System Calibration component 1114, an RF measurement/Antenna radiation pattern measurement component 1116, a data processing and analysis for pointing measurement component 1118, and a SOTM/COTM tracking and/or pointing accuracy component 1120. The calibration/survey component 1114 may be configured for directing and controlling the UAVs to perform a survey and/or calibration procedure as described with reference to FIGS. 1 to 10, modifications thereto, and/or as herein described. The antenna evaluation system 1110 and/or control station/unit 112 may include the functionality, process(es), method(s), apparatus, control station/units, UAVs, and other sensors/communication sensors and the like as described with reference to FIGS. 1 to 11a, combinations thereof, modifications thereto, and/or as described herein, and/or as the application demands.

Further aspects of the invention may include one or more apparatus and/or devices that include a communications interface, a memory unit, and a processor unit, the processor unit connected to the communications interface and the memory unit, wherein the processor unit, storage unit, communications interface are configured to perform or implement the functionality of the antenna evaluation system, the control unit/station, and/or UAVs, method(s), process(es) as described with reference to FIGS. 1 to 11b, combinations thereof, modifications thereof and/or as described herein.

In the embodiment(s) and example(s) described above the antenna evaluation system and/or the control unit/station may include computing device(s) and/or one or more server(s), which may comprise a single server or a network of servers. In some examples the functionality or parts of the functionality of the computing device and/or server may be provided by a network of servers distributed across a geographical area, such as a worldwide distributed network of servers, and a user may be connected to an appropriate one of the network of servers based upon a user location and the like.

There may be provided a computer-readable medium including data or instruction code, which when executed on one or more processor(s), causes the one or more processor(s) to implement the functionality and/or one or more function(s) or functionality associated with the antenna evaluation system, the control station/unit, one or more UAVs, method(s), process(es), any other functionality of the UAV/aircraft, payload, antenna evaluation, APE tests, COTM/SOTM operations and the like as described with reference to FIGS. 1 to 11b, combinations thereof, modifications thereof and/or as described herein and the like according to the invention.

Further modifications to the antenna evaluation system 100, antenna evaluation process(es) 200 or 300 and/or subprocess(es) and the like as described with reference to any of FIGS. 1a to 11b, modifications thereof, combinations thereto and/or as herein described may further include on or more of the features of the following first, second, third, fourth, fifth, sixth, seventh, eighth, ninth, tenth, eleventh, twelfth, thirteenth, fourteenth and/or fifteenth aspects of the invention, modifications thereto, combinations thereof and/or as herein described. The following are a list of non-limiting embodiments and/or examples of the invention, which may be combined and/or modified accordingly.

In a first aspect, there is provided a computer-implemented method of testing an antenna under test (AUT) in an antenna evaluation system comprising a control unit/station and a plurality of aircraft in communication with the control unit, each aircraft including a radio frequency (RF) sensor module for use in measuring RF radiation and/or testing the AUT, the method, performed by the control station/unit, comprising: dynamically controlling the flight paths of each of the aircraft around the AUT for collecting RF radiation measurements in relation to one or more antenna performance tests; and evaluating the antenna performance of the AUT based on the collected RF radiation measurements of the AUT in relation to the one or more antenna performance tests.

As an option, the computer-implemented method of the first aspect further comprising: receiving in-flight positions of each of the aircraft during testing of the AUT; receiving RF radiation associated with the AUT measured by each of the aircraft along each flight path taken by said aircraft; dynamically controlling the flight paths of each of the aircraft around the AUT for one or more antenna performance tests based on the real-time in-flight position of the aircraft and the received RF radiation of the AUT from each of the aircraft; and evaluating the antenna performance of the AUT based on the received RF radiation from the AUT in relation to the one or more antenna performance tests.

As an option, the computer-implemented method of the first aspect, wherein each of the plurality of aircraft is configured to: receive dynamic flight path information from the control unit; measure RF radiation associated with the AUT along the received dynamic flight path taken by said each aircraft; and transmit the RF radiation measurements to the control unit.

As an option, the computer-implemented method of the first aspect, wherein the one or more antenna performance tests include one or more from the group of: antenna tracking performance test; antenna pointing performance test; antenna de-pointing performance test; SOTM antenna performance tests; COTM antenna performance tests; GVF-105 antenna performance tests; any other suitable antenna performance evaluation test in relation to the AUT.

As an option, the computer-implemented method of the first aspect, wherein prior to dynamically controlling the flight paths and evaluating the antenna performance of the AUT the method further comprising performing: a Site Survey and System Calibration phase for surveying the test site of the AUT and calibration of the RF sensor modules of the aircraft; an Antenna radiation pattern measurement phase for measuring RF radiation pattern of the AUT including main beam localization; and a data processing and analysis phase for performing an AUT testing phase; and the AUT testing phase for estimating the antenna performance of the AUT based on one or more antenna performance tests.

As an option, the computer-implemented method of the first aspect, wherein the AUT test phase is an AUT pointing test phase when the antenna performance test is a pointing accuracy test.

As an option, the computer-implemented method of the first aspect, wherein prior to dynamically controlling the flight paths and evaluating the antenna performance of the AUT the method further comprising: in the Survey and System Calibration phase: performing a site survey of the test area around the AUT and calibration of the RF sensors of the aircraft based on controlling the flight paths of the plurality of aircraft and measuring RF radiation received by the aircraft for determining obstacles to avoid during the antenna performance tests and RF interference for calibrating the RF sensors of the aircraft; in the Antenna radiation pattern measurement phase: performing antenna radiation pattern measurements by controlling the flight paths of each of the aircraft to fly around the area of the AUT for receiving the RF measurements and corresponding in-flight positions for determining the radiation pattern of the AUT; in the data processing and analysis phase: analysing the RF measurements and positional information for determining characteristics of the AUT for use in an antenna performance test; in the AUT test phase: performing an antenna performance test based on the steps of: dynamically controlling each of the aircraft for performing one or more antenna performance tests and collecting RF measurements and corresponding positional information associated with the AUT; analysing the collected RF measurements and corresponding positional information for updating the trajectories/flight paths of the aircraft for collecting further RF measurements and corresponding positional information; and evaluating the collected RF measurements and corresponding positional information for determining the antenna performance based on the one or more antenna performance tests.

As an option, the computer-implemented method of the first aspect, wherein the antenna performance is output for use in maintaining, overhauling, re-calibrating, re-designing, adjusting the antenna and/or configuration of the antenna and the like.

As an option, the computer-implemented method of the first aspect, wherein in the data processing and analysis phase, performing one or more of: analysing the RF measurements and positional information for assisting in antenna performance tests including the antenna tracking and/or pointing tests; performing a tracking/pointing analysis in preparation for one or more of the antenna performance tests associated with tracking/pointing/de-pointing; performing an analysis of the RF measurements and corresponding positional information for determining aircraft positioning in relation to the antenna of the AUT in preparation for one or more of the antenna performance tests; and building a machine learning, ML, model/system based on inputting a training data set to a machine learning algorithm or technique, the training data set comprising data representative of RF measurement data and corresponding positional information associated with the AUT collected during the antenna radiation pattern measurement phase, wherein the ML model/system is configured to output an estimate of antenna performance of the AUT associated with an antenna performance test and/or output in-flight trajectory updates for dynamically controlling the aircraft for receiving further RF measurements and corresponding positional information based on previously received RF measurements and corresponding positional information from said aircraft during the antenna performance test;

As an option, the computer-implemented method of the first aspect, wherein in the AUT test phase: simulating motion of the AUT during one or more antenna performance tests based on one or more of: dynamically controlling the flight paths of the plurality of aircraft UAVs to simulate motion of the AUT; mounting the AUT on a motion emulator for simulating motion of the AUT;

As an option, the computer-implemented method of the first aspect, wherein the simulated motion is based on simulating motion of one or more vehicle types from the group of: land-based vehicles; maritime vehicles or ships; aircraft; highspeed trains; and any other platform onto which the AUT may be mounted that experiences motion during operation of the AUT.

As an option, the computer-implemented method of the first aspect, wherein in the AUT test phase, when an ML model/system is associated with an antenna performance test, the ML model/system receives as input data representative of real-time RF measurements and corresponding positional information from said aircraft and outputs an estimate of the antenna performance associated with the antenna performance test and/or updates or adjustments for dynamically controlling the flight paths of one of more of the aircraft for directing said aircraft to measure further RF measurements and corresponding positional information for estimating the antenna performance.

As an option, the computer-implemented method of the first aspect, wherein the trained ML model/system is configured to provide control/navigation values for aircraft in real-time/on-line immediately during the AUT test phase and/or provide waypoints for aircraft to move to for maintaining accuracy should the AUT main beam direction be mismatched from an initial state during the RF measurement in the AUT test phase.

As an option, the computer-implemented method of the first aspect, wherein in the AUT test phase when the test is a pointing accuracy test, the RF measurements are RF de-pointing measurements. As an option, the computer-implemented method of the first aspect, wherein the ML model/system is a reinforcement learning, RL, system derived from an associated RL technique. As an option, the computer-implemented method of the first aspect, wherein the RL system is configured based on a centralised critic and centralised actor/agent.

As an option, the computer-implemented method of the first aspect, wherein the RL system is configured based on a centralised critic and a plurality of decentralised actors/agents. As an option, the computer-implemented method of the first aspect, wherein the RL system is configured based on a decentralised critic and a plurality of decentralised actors/agents. As an option, the computer-implemented method of the first aspect, wherein the RL system is based on multi-agent reinforcement learning algorithm(s).

As an option, the computer-implemented method of the first aspect, wherein in the Antenna radiation pattern measurement phase: performing antenna radiation pattern measurements further comprising dynamically controlling the flight paths of each of the aircraft to find at least the main beam lobe of the AUT; and collecting RF measurements and corresponding positional information from each of the aircraft.

As an option, the computer-implemented method of the first aspect, wherein in the Antenna radiation pattern measurement phase: estimating the centre of the main beam lobe of the AUT based on an iterative feedback algorithm/system using Bayesian estimation techniques and/or ML techniques and the RF radiation measurements and positional information; autonomously and dynamically adjusting the position and orientation of a circle or spiral defining each of the aircraft's flight paths based on the estimated beam centre, wherein flight path adjustments are dynamically generated by the control unit and sent to the each of the corresponding aircraft in each iteration of the iterative feedback algorithm/system.

As an option, the computer-implemented method of the first aspect, wherein in the Antenna radiation pattern measurement phase: estimating the centre of the main beam lobe of the AUT based on an iterative gradient ascent algorithm using the RF radiation measurements and positional information; autonomously and dynamically adjusting the position and orientation of each of the aircraft's flight paths based on the estimated beam centre, wherein flight path adjustments are dynamically generated by the control unit and sent to the each of the corresponding aircraft in each iteration of the gradient ascent algorithm or raster scan approach or cross-section approach or using a RL algorithm.

As an option, the computer-implemented method of the first aspect, wherein in the AUT test phase, the method further comprising: designating at least one aircraft to be a pseudo satellite and a plurality of other aircraft to form a flight formation around the pseudo satellite aircraft, wherein the designated aircraft is configured to transmit a pseudo satellite signal to the AUT; simulating motion of the vehicle under the AUT during the tracking/pointing test mode based on either a motion emulation platform attached to the AUT or dynamically adjusting the flight paths of at least the pseudo satellite aircraft; dynamically controlling the flight path of the pseudo satellite aircraft and the other aircraft's flight formation based on the identified and measured main beam lobe(s) of the satellite AUT; the other aircraft except for the pseudo satellite aircraft are stationary fixed w.r.t the LOS to the target satellite position; and analysing the received RF radiation measured by each of the aircraft for determining the tracking or pointing performance of the AUT.

As an option, the computer-implemented method of the first aspect, wherein in the Antenna radiation pattern measurement phase: analysing the measured RF radiation for dynamically adjusting the flight paths of each of the aircraft to identify and measure at least the main beam lobe(s) of the RF radiation pattern of the AUT; and identifying at least the main beam lobe(s) of the RF radiation pattern of the AUT based on the received RF measurements.

As an option, the computer-implemented method of the first aspect, wherein in the AUT test phase: designating at least one UAV to be a pseudo satellite and a plurality of other UAVs to form a flight formation around the pseudo satellite UAV, wherein the designated UAV is configured to transmit a pseudo satellite signal to the AUT; simulating motion for the AUT during the tracking/pointing test mode based on either a motion emulation platform attached to the AUT or dynamically adjusting the flight paths of at least the pseudo satellite UAV; dynamically controlling the flight path of the pseudo satellite UAV and the other UAV's flight formation based on the identified and measured main beam lobe(s) of the satellite AUT; and analysing the received RF radiation measured by each of the UAVs for determining the tracking or pointing performance of the AUT.

As an option, the computer-implemented method of the first aspect, wherein for the AUT test phase, the method further comprising dynamically controlling the flight paths of the aircraft to ensure the pseudo satellite aircraft is in the centre of the flight formation of other aircraft, wherein each of the other aircraft are positioned substantially equidistant around the pseudo satellite aircraft.

As an option, the computer-implemented method of the first aspect, wherein the AUT is a phased array antenna, and in the AUT test phase, the method further comprising dynamically controlling the flight formation of the other aircraft around the pseudo satellite aircraft to form a line formation or a 2-dimensional formation of aircraft, and dynamically adjusting the flight paths of the other aircraft to rotate the line formation or the 2-dimensional formation of aircraft around the pseudo satellite aircraft.

As an option, the computer-implemented method of the first aspect, wherein the antenna test system is a satellite antenna evaluation system, the satellite antenna evaluation system comprising the control unit and the plurality of aircraft, wherein each of the plurality of aircraft are unmanned aerial vehicles, UAVs, and the AUT is a satellite AUT, each of the UAVs including a satellite RF sensor module for measuring RF radiation associated with the satellite AUT, the method performed by the control unit further comprising: dynamically controlling the flight paths of each of the UAVs in relation to the AUT based on a set of evaluation test modes, the set of evaluation test modes comprising: an antenna measurement mode of operation, wherein the method further comprising: analysing the measured RF radiation for dynamically adjusting the flight paths of each of the UAVs to identify and measure at least the main beam lobe(s) of the RF radiation pattern of the satellite AUT; and identifying at least the main beam lobe(s) of the RF radiation pattern of the satellite AUT based on the received RF measurements; and a tracking/pointing accuracy test mode of operation, wherein the method further comprising: designating at least one UAV to be a pseudo satellite and a plurality of other UAVs to form a flight formation around the pseudo satellite UAV, wherein the designated UAV is configured to transmit a pseudo satellite signal to the AUT; simulating motion for the AUT during the tracking/pointing test mode based on either a motion emulation platform attached to the AUT or dynamically adjusting the flight paths of at least the pseudo satellite UAV; dynamically controlling the flight path of the pseudo satellite UAV and the other UAV's flight formation based on the identified and measured main beam lobe(s) of the satellite AUT; and analysing the received RF radiation measured by each of the UAVs for determining the tracking or pointing performance of the AUT.

As an option, the computer-implemented method of the first aspect, wherein the set of evaluation test modes further comprising a site survey and calibration test mode, wherein the control unit is configured to perform the steps of: analysing the received measured RF radiation for dynamically adjusting the flight paths of the UAVs to identify and measure possible sources of radio frequency interference in the vicinity of the satellite AUT; and adjusting the RF sensors of each UAV based on the measured RF radiation for taking into account any sources of radio frequency interference when measuring RF radiation associated with the satellite AUT;

As an option, the computer-implemented method of the first aspect, wherein for the tracking/pointing test mode, the control unit performs the step of dynamically controlling the flight paths of the UAVs to ensure the pseudo satellite UAV is in the centre of the flight formation of other UAVs, wherein each of the other UAVs positioned substantially equidistant around the pseudo satellite UAV.

As an option, the computer-implemented method of the first aspect, wherein the AUT is a phased array antenna, and in the tracking/pointing test mode, the control unit performs the step of dynamically controlling the flight formation of the other UAVs around the pseudo satellite UAV to form a line formation or a 2-dimensional formation of UAVs, wherein the control unit is configured to dynamically adjust the flight paths of the other UAVs in order to rotate the line formation or the 2-dimensional formation of UAVs around the pseudo satellite UAV.

As an option, wherein the control unit is configured to dynamically adjust the flight paths of the other UAVs in order to rotate the line formation or the 2-dimensional formation of UAVs around the pseudo satellite UAV, while the AUT is in motion based on a motion table for simulating the motion for the AUT.

As an option, wherein the control unit is configured to dynamically adjust the flight paths of the other UAVs in order to rotate the line formation or the 2-dimensional formation of UAVs around the pseudo satellite UAV, while tracking a target satellite by adjusting steering angle.

As an option, the computer-implemented method of the first aspect, further comprising: calculating the pointing accuracy based on using a Bayesian filter involving RF measurement results, the dynamics of the positions of the UAVs, control unit, and AUT, with Friis' law, Friis' Equation or Friis' Transmission Equation.

As an option, the computer-implemented method of the first aspect, further comprising: analysing the RF measurements from the UAVs using a decentralised computational structure, wherein the plurality of UAVs is divided into multiple sets of UAVs, wherein the positions of each UAV in a set of UAVs is localised and the RF measurements from each set of UAVs is analysed to form a local estimation of the beam lobe or pointing accuracy, and each of the local estimations associated multiple sets of UAVs are combined to form the final estimation of the beam lobe or pointing accuracy.

As an option, the computer-implemented method of the first aspect, further comprising: using Bayesian estimation techniques to estimate the centre of the main beam based on the measured signal level from each of the plurality of UAVs, and dynamically adjusting the position and orientation of each of the UAV's flight path to home in on the main beam of the AUT.

As an option, the computer-implemented method of the first aspect, further comprising: iteratively using Bayesian estimation techniques to dynamically control the flight paths of each of the UAV's in a circular or spiral flight path, which is adjusted in each iteration, to home in on the main beam of the AUT.

As an option, the computer-implemented method of the first aspect, wherein receiving the in-flight position of the aircraft further comprising receiving data representative of global positioning system, GPS, position, heading, altitude and/or attitude of the aircraft.

As an option, the computer-implemented method of the first aspect, further comprising receiving the position of the AUT further comprising receiving data representative of information associated with the position of the AUT.

As an option, the computer-implemented method of the first aspect, wherein the RF sensor module and/or communication sensor interface of an aircraft further comprises at least one from the group of: a receiver; a transmitter; a transceiver; and/or any other communication sensor interface configured for testing the AUT and/or communicating with the control unit.

As an option, the computer-implemented method of the first aspect, wherein each of the plurality of aircraft is configured to: receive dynamic flight path information from the control unit; measure RF radiation associated with the AUT along the received dynamic flight path taken by said each UAV; or generate a flight path based on available information and communication received; transmit the RF radiation measurements to the control unit; output the flight path.

In a second aspect, there is provided a control station for an antenna evaluation system comprising the control station and a plurality of aircraft, the control station comprising a processor unit, a memory unit, and a communication interface, the processor unit connected to the memory unit and the communication interface, wherein the processor unit, memory unit and communication interface are adapted to implement the computer-implemented method including any of the features and/or steps of the first aspect, modifications thereof, combinations thereof, and/or as herein described.

In a third aspect, there is provided an antenna evaluation system comprising a control unit/station and a plurality of aircraft, each of the aircraft capable of communicating with the control unit/station and measuring RF measurements from and/or transmit RF signals to an antenna under test, the control unit configured to dynamically control the flight of the plurality of aircraft for measuring RF radiation measurements of the AUT during an antenna performance test and analysing the received RF radiation measurements for determining the antenna performance of the AUT in relation to the antenna performance test.

As an option, the antenna evaluation system of the third aspect, the control unit/station further adapted to implement the computer-implemented method including any of the features and/or steps of the first aspect, modifications thereof, combinations thereof, and/or as herein described.

In a fourth aspect, there is provided an apparatus comprising a processor unit, a memory unit, and a communication interface, the processor unit connected to the memory unit and the communication interface, wherein the processor unit, memory unit and communication interface are adapted to implement the computer-implemented method including any of the features and/or steps of the first aspect, modifications thereof, combinations thereof, and/or as herein described.

In a fifth aspect, there is provided a system comprising: a control unit comprising an apparatus according to the fourth aspect; a plurality of aircraft in communication with the control unit; and an antenna under test, wherein the aircraft are configured to perform testing of the AUT under control of the control unit.

In a sixth aspect, there is provided a computer-implemented method, control station/unit, antenna evaluation system, apparatus, or system of any preceding claim, wherein the aircraft is an unmanned aerial vehicle.

In a seventh aspect, there is provided a computer-readable medium comprising computer code or instructions stored thereon, which when executed on a processor, causes the processor to the computer-implemented method including any of the features and/or steps of the first aspect, modifications thereof, combinations thereof, and/or as herein described.

In a seventh aspect, the present disclosure provides a computer-readable medium comprising computer code or instructions stored thereon, which when executed on a processor, causes the processor to the computer-implemented method including any of the features and/or steps of the first aspect, modifications thereof, combinations thereof, and/or as herein described.

In an eighth aspect, there is provided a system as herein described with reference to the accompanying drawings.

In a ninth aspect, there is provided a method as herein described with reference to the accompanying drawings.

In a tenth aspect, there is provided an apparatus as herein described with reference to the accompanying drawings.

In a eleventh aspect, there is provided a antenna evaluation process as herein described with reference to the accompanying drawings.

In a twelfth aspect, there is provided a antenna evaluation system as herein described with reference to the accompanying drawings.

In a thirteenth aspect, there is provided a control station/unit as herein described with reference to the accompanying drawings.

In a fourteenth aspect, there is provided a reinforcement learning system for use in an antenna evaluation system or process as herein described with reference to the accompanying drawings.

In a fifteenth aspect, there is provided a computer program product as herein described with reference to the accompanying drawings.

In the embodiment(s), example(s), aspect(s) and/or option(s) described above the server may comprise a single server or network of servers. In some examples the functionality of the server may be provided by a network of servers distributed across a geographical area, such as a worldwide distributed network of servers, and a user may be connected to an appropriate one of the network of servers based upon a user location.

The above description discusses embodiments of the invention with reference to a single user for clarity. It will be understood that in practice the system may be shared by a plurality of users, and possibly by a very large number of users simultaneously.

The embodiments described above may be fully automatic and/or semi-automatic. In some examples a user or operator of the system may manually instruct some steps of the method/process(es) to be carried out when operating the antenna evaluation system, control station/units and/or UAVs and the like as the application demands.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Application-Program-specific Integrated Circuits (ASICs), Application-Program-specific Standard Products (ASSPs), System-on-a-chip systems (SOCs), Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program.

Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

The present disclosure can be described further with respect to the following clauses:

1. A computer-implemented method of testing an antenna under test, AUT, in an antenna evaluation system comprising a control unit/station and one or more aircraft in communication with the control unit, each aircraft including a radio frequency, RF, sensor module as payload for use in measuring RF radiation and/or testing the AUT (106), the method, performed by the control station/unit, comprising:
dynamically controlling the flight paths of each of the one or more aircraft around the AUT for collecting RF radiation measurements in relation to a tracking accuracy test, wherein the one or more aircraft is controlled to mimic a satellite and/or track a main bream direction of the AUT when installed on a moving vehicle or a motion emulator; and
operating an algorithm using a Kalman filter to estimate a heading angle or main beam direction of the AUT.

2. The computer-implemented method as defined in clause 1, further including calculating the de-pointing angle (dω) based on the estimated heading angle or main beam direction of the AUT.

3. The computer-implemented method of any preceding clause, wherein a prediction stage of the Kalman filter involves calculating a posteriori state vector of the AUT based on a priori state vector of the AUT, wherein the state vector represents the heading angle or main beam direction, a control vector, wherein the control vector represents a displacement of a target satellite during a time step, and process noise.

4. The computer-implemented method of any preceding clause, wherein a correction stage of the Kalman filter refines the posteriori state vector from calculated Kalman gain and innovation using prior state and covariance estimation and a measured signal strength.

5. The computer-implemented method of clause 4, wherein a measurement function (formula (30)) with respect to the state of the AUT is prepared by approximating a pre-measured radiation pattern to a function using Spline interpolation, wherein the Jacobian (formula (33)) is obtained from a partial derivative of the radiation pattern.

6. The computer-implemented method as defined in any preceding clause, wherein the Kalman filer is an Extended Kalman filter.

7. The computer-implemented method as defined in any preceding clause, wherein the algorithm comprises a multisensor fusion technique for combining information and/or RF radiation measurement data, wherein the multisensor fusion technique includes one or more Kalman filters and RF radiation measurement data is obtained from the multiple RF sensor modules as the payload of the one or more aircraft.

8. The computer-implemented method as defined in clause 7, wherein RF radiation measurement data from each RF sensor module is combined and the posteriori state vector is estimated from the fused RF radiation measurement data.

9. The computer-implemented method as defined in clause 7, wherein the multisensor fusion technique comprises a plurality of Kalman filters equal to the number of RF sensor modules, wherein the posteriori state vectors are centrally fused using a weighted sum, and wherein each Kalman filter uses its own posteriori state vector estimation for the prediction stage in the next time step.

10. The computer-implemented method as defined in clause 7, wherein the multisensor fusion technique comprises a plurality of Kalman filters equal to the number of RF modules, wherein the posteriori state vectors are centrally fused using a weighted sum and a fused estimation is used as input for the prediction stage in the next time step.

11. The computer-implemented method as defined in any preceding clause, wherein the AUT is a communication on the move (COTM) or satellite communication on the move (SOTM) antenna.

12. The computer-implemented method as defined in any preceding clause, further evaluating the antenna performance of the AUT based on the received RF radiation from the AUT in relation to the tracking accuracy test.

13. A control station for an antenna evaluation system comprising the control station and one or more aircraft, the control station comprising a processor unit, a memory unit, and a communication interface, the processor unit connected to the memory unit and the communication interface, wherein the processor unit, memory unit and communication interface are adapted to implement the computer-implemented method as defined in any of clauses 1 to 12.

14. An antenna evaluation system comprising a control unit/station and one or more aircraft, each of the aircraft capable of communicating with the control unit/station and measuring RF measurements from receive and/or transmit RF signals to an antenna under test, the control unit configured to dynamically control the flight paths of each of the one or more aircraft around the AUT for collecting RF radiation measurements in relation to a tracking accuracy test, wherein the one or more aircraft is controlled to mimic a satellite and/or track a main bream direction of AUT's when installed on a moving vehicle; and to operate an algorithm using a Kalman filter to estimate a heading angle or main beam direction of the AUT.

15. The antenna evaluation system as defined in clause 14, the control unit/station further adapted to implement the computer-implemented method according to any of clauses 1 to 12.

16. A computer-readable medium comprising computer code or instructions stored thereon, which when executed on a processor, causes the processor to perform the computer implemented method according to any of clauses 1 to 12.

1-46. (canceled)

47. A method for evaluating satellite terminal antenna, or Antenna Under the Test (AUT), performance, the method comprising:
performing a survey for a test site of the AUT and calibrate a payload of at least one aircraft based on the survey;
measuring an RF radiation pattern for the AUT using said at least one aircraft; processing data associated with the measured RF radiation pattern for the AUT testing; and
testing the AUT by said at least two aircraft mimicking a satellite and/or tracking a main bream direction of the AUT to provide the AUT tracking performance.

48. The method of claim 47, wherein said performing survey for a test site of the AUT and calibrate a payload of at least one aircraft based on the survey further comprising:
defining an area of interest for the survey;
planning one or more flight paths for said at least one aircraft in the defined area, wherein the defined area is assessed and the payload of said at least one aircraft is calibrated to ensure valid evaluation by a control unit.

49. The method of claim 48, wherein said one or more flight paths are planned dynamically.

50. The method of claim 48, wherein said one or more flight paths are planned to utilize sensor technology and/or predictive algorithms to avoid observable objects on said one or more flight paths.

51. The method of claim 48, wherein said planning one or more flight paths for said at least one aircraft in the defined area further comprising: selecting a portion of the area of interest for repeated flight path planning to obtain further RF measurements.

52. The method of claim 51, wherein the flight path planning is performed for emitter localization or during emitter geolocation.

53. The method of claim 47, wherein said measuring an RF radiation pattern for the AUT using said at least one aircraft further comprising:
localising a main beam centre based on a beam localization algorithm;
defining a coordinate system corresponding to the main bream centre; and
measuring the RF radiation pattern based on the coordinate system using said at least one aircraft taking one or more flight paths.

54. The method of claim 51, wherein the AUT is a pattern varying antenna, that tracks multiple beams of the pattern varying antenna using one or more aircrafts comprising:

55. The method of claim 47, wherein said processing data associated with the measured RF radiation pattern for the AUT testing further comprising: supplying a reference for the AUT testing based on said data associated with the measured RF radiation pattern, wherein the reference defines the placement of one or more sensors a part of the payload on said at least one aircraft.

56. The method of claim 55, wherein said one or more sensors are placed dynamically based on an estimated pointing angle of the AUT.

57. The method of claim 55, wherein said one or more sensors are placed statically based on a position around a direction of a target satellite.

58. The method of claim 47, wherein said testing the AUT by said at least two aircraft mimicking a satellite and/or tracking a main bream direction of the AUT to provide the AUT tracking performance further comprising: applying one or more algorithms to estimate a main beam direction of the AUT based on said data processed prior to the AUT testing.

59. The method of claim 58, wherein said one or more algorithms comprise Kalman filter for estimating the main beam direction, wherein the Kalman filter is used in combination with sensor fusion to improve the main beam direction estimation.

60. (canceled)

61. A system for evaluating satellite terminal antenna, or Antenna Under the Test (AUT), performance, the system comprising:
a control unit and one or more aircraft in communication with the control unit, each aircraft comprises a radio frequency (RF) payload for use in receiving RF measurements from and/or transmit RF signals to the AUT, wherein the payload of at least one aircraft of said one or more aircraft is configured to receive the RF measurements and the transmit RF signals to the AUT simultaneously;
the control unit is adapted to apply a set of phases in relation to the received RF measurements from said one or more aircraft, wherein the set of phases comprise a Site Survey and System Calibration phase an Antenna radiation pattern measurement phase, a data processing and analysis phase, and an AUT testing phase; and
the control unit is configured to operate said one or more aircraft in relation to the set of applied phases by mimicking a satellite and/or tracking a main bream direction of the AUT for providing the AUT tracking performance.

62. (canceled)

63. (canceled)

64. The system of claim 61, wherein the control unit further comprising:
a reinforcement learning (RL) system comprises an agent that interacts with an environment associated with the AUT by receiving at each time step an observation characterizing a current state of said one or more aircrafts in the environment for,
the agent selects an action to be performed from a predetermined set of actions, wherein the predetermined set of actions comprises actions selected by the agent based on using a function that is configured to receive as input the observation and to generate an output from said input in accordance with a set of parameters, wherein said input is associated with data from sensors of said one or more aircraft;
the RL system is configured to navigation said one or more aircraft, based on the actions taken or selected by the agent, during at least one phase of AUT evaluation or provide waypoints for each aircraft to move.

65. The method of claim 64, wherein the set of parameters comprise at least beamwidth degree, signal-to-noise ratio (SNR), and initial relative position in the spherical angle.

66. The method of claim 64, wherein training the RL system comprises adjusting the values of the set of parameters of the RNN to encourage the agent to move to position expecting higher Effective Isotropic Radiated Power (EIRP) based on the reward r=ΔPᵣ−0.1, where ΔPᵣ is variance of the received power, EIRP, from the previous time step for the RL system.

67. The method of claim 64, wherein the control unit is adapted to apply the RL system in one or more phases comprising: a Site Survey and System Calibration phase, an Antenna radiation pattern measurement phase, a data processing and analysis phase, and an AUT testing phase.

68. The method of claim 67, wherein the control unit is configured to operate said one or more aircraft in relation to said one or more phases by mimicking a satellite and/or tracking a main bream direction of the AUT for providing the AUT tracking performance.

69. The method of claim 64, wherein the function is a recurrent neural network (RNN).
